(19) United States
(12) Patent Application Publication
(10) Pub. No.: US 2020/0290266 A1
(43) Pub. Date: Sep. 17, 2020

(54) Materials, Methods and Systems for Printing Three-Dimensional Objects by Direct Energy Deposition

(71) Applicant: Arevo, Inc., Milpitas, CA (US)

(72) Inventors: Sanjiv Bhatt, San Jose, CA (US); Hemant Bheda, Saratoga, CA (US)

(73) Assignee: Arevo, Inc., Milpitas, CA (US)

(21) Appl. No.: 16/767,074

(22) PCT Filed: Nov. 27, 2018
(86) PCT No.: PCT/US2018/062585

§ 371 Date: May 26, 2020

Related U.S. Application Data
(60) Provisional application No. 62/591,655, filed on Nov. 28, 2017.

(51) Int. Cl. B29C 64/118; B29C 64/393; B33Y 10/00; B33Y 50/02; B33Y 70/00

(52) U.S. Cl. CPC B29C 64/118; B29C 64/393; B33Y 70/00; B33Y 50/02; B33Y 10/00

(57) ABSTRACT

The present disclosure provides methods and systems for printing a three-dimensional (3D) object. A model of the 3D object, in computer memory, may be received. Next, at least one filament material from a source may be directed towards a build platform configured to support the 3D object, thereby depositing a first layer of a portion of the 3D object. The at least one filament material may be used to deposit a second layer corresponding to at least a portion of the 3D object. The first and second layers may be deposited in accordance with the model of the 3D object. While, the second layer is being deposited, at least one energy beam may selectively heat a first portion of the first layer and a second portion of the at least one filament material. The first portion may be brought in contact with the second portio-n

### CROSS-REFERENCE

This application claims priority to U.S. Provisional Patent Application No. 62/591,655, filed Nov. 28, 2017, which is entirely incorporated herein by reference.

This application is a 35 U.S.C. § 371 national filing of International Application No. PCT/US2018/062585, which is incorporated by reference.

### BACKGROUND

Additive manufacturing has been utilized for printing three-dimensional parts by depositing successive layers of material in an automated manner. Techniques of additive manufacturing include, without limitation, fused deposition modeling (FDM), fused filament fabrication (FFF), Plastic Jet Printing (PJP), extrusion-based techniques, jetting, selective laser sintering, powder/binder jetting, electron-beam melting, and stereolithographic processes. Using these techniques, a material (e.g., a heated and/or pressurized thermoplastic) may pass through a print head. The print head may be moved in a predefined trajectory (e.g., a tool path) as the material discharges from the print head, such that the material is laid down in a particular pattern and shape of overlapping layers. The material, after exiting the print head, may harden into a final form.

### SUMMARY

In an aspect, the present disclosure provides a method for printing at least a portion of a three-dimensional (3D) object, comprising (a) receiving, in computer memory, a computer model (model) of the 3D object; (b) directing at least one filament material from a source of the at least one filament material towards a build platform that is configured to support the 3D object, thereby depositing a first layer corresponding to a portion of the 3D object adjacent to the build platform, which first layer is deposited in accordance with the model of the 3D object; (c) using the at least one filament material to deposit a second layer corresponding to at least a portion of the 3D object, which second layer is deposited in accordance with the model of the 3D object; and (d) while the second layer is being deposited, using at least a first energy beam from at least one energy source to selectively heat a first portion of the first layer and a second portion of the at least one filament material, which first portion is brought in contact with the second portion.

In some embodiments, the method for printing at least a portion of the 3D object further comprises the depositing of the first layer corresponding to the at least the portion of the 3D object is performed without heating the at least one filament material.

In some embodiments, the method for printing at least a portion of the 3D object further comprises, prior to (b), directing at least one additional filament material from a source of the at least one second filament material towards the build platform, thereby depositing at least one adhesion layer adjacent to the build platform to support the 3D object. In some embodiments, the at least one additional filament material is the at least one filament material. In some embodiments, the at least one adhesion layer is not part of the 3D object. In some embodiments, the method for printing at least a portion of the 3D object further comprises, prior to (c), heating at least a portion of the first layer. In some embodiments, the method for printing at least a portion of the 3D object further comprises, depositing one or more additional layers over the first layer and the second layer. In some embodiments, the method for printing at least a portion of the 3D object further comprises compacting the first layer during or subsequent to deposition of the first layer. In some embodiments, the method for printing at least a portion of the 3D object further comprises compacting the first layer or the second layer during or subsequent to deposition of the first layer or the second layer. In some embodiments, the method for printing at least a portion of the 3D object further comprises compacting the portion of the at least one filament material subsequent to heating the portion of the first layer and the portion of the at least one filament material. In some embodiments, the method for printing at least a portion of the 3D object further comprises compacting the second layer subsequent to heating the portion of the first layer and the second portion of the at least one filament material. In some embodiments, in (d), the at least the first energy beam from the at least one energy source selectively melts the portion of the first layer and the portion of the at least one filament material. In some embodiments, the at least one filament material is a bundle of filament materials. In some embodiments, the bundle of filament material comprises a polymeric material and a reinforcing material. In some embodiments, the filament material comprises one or more elements selected from the group consisting of continuous fiber, long fiber, short fiber, and milled fiber. In some embodiments, the filament material comprises one or more elements selected from the group consisting of carbon nanotube, graphene, Bucky ball(s), and metallic material (e.g., elemental metal or metal alloy).

In another aspect, the present disclosure provides a method for printing at least a portion of a three-dimensional (3D) object, comprising (a) receiving, in computer memory, a model of the 3D object; (b) using at least one feedstock from a source of the at least one feedstock to deposit a first layer adjacent to a build platform, which first layer is deposited in accordance with the model of the 3D object, wherein the at least one feedstock comprises a polymeric material and a reinforcing material as a bundle, and wherein a ratio of a first dimension to a second dimension orthogonal to the first dimension of the at least one feedstock is less than 10:1; and (c) using the at least one feedstock from the source of the at least one feedstock to deposit a second layer adjacent to the first layer, which second layer is deposited in accordance with the model of the 3D object. In some embodiments the at least one feedstock is not a tape. In some embodiments, the ratio is less than 5:1. In some embodiments, the ratio is less than 2:1. In some embodiments, the ratio is from about 1:2 to 2:1. In some embodiments, the reinforcing material is selected from the group consisting of continuous fiber, long fiber, short fiber, and milled fiber. In some embodiments, the reinforcing material is selected from the group consisting of carbon nanotube, graphene, Bucky balls, and metallic material.

In an another aspect, the present disclosure provides a system for printing at least a portion of a three-dimensional (3D) object, comprising a source of at least one filament material; computer memory configured to receive a model of the 3D object; a least one energy source configured to provide at least one energy beam; and one or more computer processors operatively coupled to the computer memory and the at least one energy source, wherein the one or more computer processors are individually or collectively programmed to (i) direct the at least one filament material from the source of the at least one filament material towards a build platform configured to support the 3D object, thereby depositing a first layer corresponding to a portion of the 3D object adjacent to the build platform, which first layer is deposited in accordance with the model of the 3D object from the computer memory; (ii) direct the at least one filament material to deposit a second layer corresponding to the at least the portion of the 3D object, which second layer is deposited in accordance with the model of the 3D object; and (iii) while the second layer is being deposited, direct the at least one energy source to provide the at least one energy beam to selectively heat a first portion of the first layer and a second portion of the at least one filament material, which first portion is brought in contact with the second portion.

In some embodiments, the system for printing at least a portion of the 3D object further comprises the one or more computer processors are individually or collectively programmed to deposit the first layer corresponding to the portion of the 3D object without heating the at least one filament material.

In some embodiments, the system for printing at least a portion of the 3D object further comprises the one or more computer processors are individually or collectively programmed to, prior to (i), directing at least one additional filament material from a source of the at least one additional filament material towards the build platform, thereby depositing at least one adhesion layer adjacent to the build platform to support the 3D object. In some embodiments, the at least one additional filament material is the at least one filament material. In some embodiments, during use, the at least one adhesion layer is not part of the 3D object. In some embodiments, wherein the one or more computer processors are individually or collectively programmed to, prior to (ii), direct heating of at least a portion of the first layer. In some embodiments, the one or more computer processors are individually or collectively programmed to direct deposition of one or more additional layers over the first layer and the second layer. In some embodiments the one or more computer processors are individually or collectively programmed to direct compaction of the first layer during or subsequent to deposition of the first layer. In some embodiments the one or more computer processors are individually or collectively programmed to direct compaction of the first layer or the second layer during or subsequent to deposition of the first layer or the second layer.

In some embodiments, the one or more computer processors are individually or collectively programmed to direct compaction of the second layer subsequent to heating the portion of the first layer and the second portion of the at least one filament material.

In some embodiments, the one or more computer processors are individually or collectively programmed to, in (iii), direct the at least the energy beam from the at least one energy source to selectively melt the first portion of the first layer and the second portion of the at least one filament material.

In some embodiments, the at least one filament material is a bundle of filament materials. In some embodiments, the bundle of filament material comprises a polymeric material and a reinforcing material. In some embodiments, the at least one filament material comprises one or more elements selected from the group consisting of continuous fiber, long fiber, short fiber, and milled fiber. In some embodiments, the at least one filament material comprises one or more elements selected from the group consisting of carbon nanotube, graphene, Bucky ball, and metallic material.

In another aspect, the present disclosure provides a system for printing at least a portion of a three-dimensional (3D) object, comprising a source of at least one feedstock; computer memory configured to receive a model of the 3D object; one or more computer processors operatively coupled to the computer memory, wherein the one or more computer processors are individually or collectively programmed to (i) direct use of the at least one feedstock from the source of the at least one feedstock to deposit a first layer adjacent to a build platform, which first layer is deposited in accordance with the model of the 3D object, wherein the at least one feedstock comprises a polymeric material and a reinforcing material as a bundle, and wherein a ratio of a first dimension to a second dimension orthogonal to the first dimension of the at least one feedstock is less than 10:1; (ii) direct use of the at least one feedstock from the source of the at least one feedstock to deposit a second layer adjacent to the first layer, which second layer is deposited in accordance with the model of the 3D object.

In some embodiments, the system for printing at least a portion of the 3D object further comprises, wherein during use, the at least one feedstock is not a tape. In some embodiments, wherein during use, the ratio is less than 5:1. In some embodiments, wherein during use, the ratio is less than 2:1. In some embodiments, wherein during use, the ratio is from about 1:2 to 2:1. In some embodiments, wherein during use, the reinforcing material is selected from the group consisting of continuous fiber, long fiber, short fiber, and milled fiber. In some embodiments, wherein during use, the reinforcing material is selected from the group consisting of carbon nanotube, graphene, Bucky ball, and metallic material.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure may become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications and patent applications mentioned in this specification are herein incorporated by reference to the same extent as if each individual publication or patent application was specifically and individually indicated to be incorporated by reference.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “figure” and “FIG.” herein), of which:

FIG. 1 shows an example system that may be used to produce a three-dimensional object having any desired or predetermined shape, size, and/or structure using an energy source and a compaction unit; and

FIG. 2 illustrates a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

The term “three-dimensional printing” (also “3D printing”), as used herein, generally refers to a process or method for generating a 3D part (or object). For example, 3D printing may refer to sequential addition of material layer or joining of material layers or parts of material layers to form a three-dimensional (3D) part, object, or structure, in a controlled manner (e.g., under automated control). In the 3D printing process, the deposited material can be fused, sintered, melted, bound or otherwise connected to form at least a part of the 3D object. Fusing the material may include melting or sintering the material. Binding can comprise chemical bonding. Chemical bonding can comprise covalent bonding. Examples of 3D printing include additive printing (e.g., layer by layer printing, or additive manufacturing). The 3D printing may further comprise subtractive printing.

The term “part,” as used herein, generally refers to an object. A part may be generated using 3D printing methods and systems of the present disclosure. A part may be a portion of a larger part or object, or an entirety of an object. A part may have various form factors, as may be based on a computer model (model) of such part, such as a computer aided design (CAD) model. Such form factors may be predetermined.

The term “composite material,” as used herein, generally refers to a material made from two or more constituent materials with different physical or chemical properties that, when combined, produce a material with characteristics different from the individual components.

The term “fuse”, as used herein, generally refers to binding, agglomerating, or polymerizing. Fusing may include melting, softening or sintering. Binding may comprise chemical binding. Chemical binding may include covalent binding. The energy source resulting in fusion may supply energy by a laser, a microwave source, source for resistive heating, an infrared energy (IR) source, a ultraviolet (UV) energy source, hot fluid (e.g., hot air), a chemical reaction, a plasma source, a microwave source, an electromagnetic source, or an electron beam. Resistive heating may be joule heating. A source for resistive heating may be a power supply. The hot fluid may have a temperature greater than or equal to about 25 Celsius (° C.), 40° C., 50° C., 60° C., 70° C., 80° C., 90° C., 100° C., 150° C., 200° C., 250° C., 300° C., 350° C., 400° C., 450° C., 500° C., or more. The hot fluid may have a temperature that may be less than or equal to about 500° C., 450° C., 400° C., 350° C., 300° C., 250° C., 200° C., 150° C., 100° C., 50° C., or less. The hot fluid may have a temperature from about 25° C. to 500° C., 25° C. to 400° C., 25° C. to 300° C., 25° C. to 200° C., 25° C. to 100° C., 25° C. to 50° C., 100° C. to 500° C., 100° C. to 400° C., 100° C. to 300° C., 100° C. to 200° C., 300° C. to 500° C., or 300° C. to 400° C. The hot fluid may have a temperature that may be selected to soften or melt a material used to print an object. The hot fluid may have a temperature that may be at or above a melting point or glass transition point of a polymeric material. The hot fluid can be a gas or a liquid. In some examples, the hot fluid may be argon or air.

The term “adjacent” or “adjacent to,” as used herein, generally refers to ‘on,’ ‘over, ‘next to,’ adjoining,’ ‘in contact with,’ or ‘in proximity to.’ In some instances, adjacent components are separated from one another by one or more intervening layers. For example, a first layer adjacent to a second layer can be on or in direct contact with the second layer. As another example, a first layer adjacent to a second layer can be separated from the second layer by at least one third layer. The one or more intervening layers may have a thickness that may be greater than or equal to about 0.5 nanometers (nm), 1 nm, 10 nm, 100 nm, 500 nm, 1 micrometer (micron), 10 microns 20 microns, 30 microns, 40 microns, 50 microns, 60 microns, 70 micron, 80 microns, 90 microns, 100 microns, 200 microns, 300 microns, 400 microns, 500 microns, 600 microns, 700 microns, 800 microns, 900 microns, 1000 microns or more. The one or more intervening layers may have a thickness that may be less than or equal to about 1000 micrometers, 900 microns, 800 microns, 700 microns, 600 microns, 500 microns, 400 microns, 300 microns, 200 microns, 100 microns, 90 microns, 80 microns, 70 microns, 60 microns, 50 microns, 40 microns, 30 microns, 20 micron, 10 microns, 1 micron, 500 nm, 100 nm, 50 nm, 10 nm, 1 nm, 0.5 nm, or less. The one or more intervening layers may have a thickness level of from about 0.5 nm to 1000 microns, 0.5 nm to 800 microns, 0.5 nm to 600 microns, 0.5 nm to 400 microns, 0.5 nm to 200 microns, 0.5 nm to 100 microns, 0.5 nm to 50 microns, 0.5 nm to 10 microns, 0.5 nm to 1 microns, 0.5 nm to 500 nm, 0.5 nm to 100 nm, 0.5 nm to 10 nm, 0.5 nm to 1 nm, 100 nm to 1000 microns, 100 nm to 800 microns, 100 nm to 600 microns, 100 nm to 400 microns, 100 nm to 200 microns, 100 nm to 100 microns, 100 nm to 50 microns, 100 nm to 10 microns, 100 nm to 1 microns, 100 nm to 500 nm, 1 micron to 1000 microns, 1 micron to 800 microns, 1 micron to 600 microns, 1 micron to 400 microns, 1 micron to 200 microns, 1 micron to 100 microns, 1 micron to 50 microns, 1 micron to 10 microns, 100 microns to 1000 microns, 100 microns to 800 microns, 100 microns to 600 microns, 100 microns to 400 microns, 100 microns to 200 microns, 500 microns to 1000 microns, 500 microns to 800 microns, or 500 microns to 600 microns.

Examples of 3D printing methodologies comprise wire, granular, laminated, light polymerization, VAT photopolymerization, material jetting, binder jetting, sheet lamination, directed energy deposition, extrusion, power bed and inkjet-based 3D printing. 3D printing can comprise robo-casting, fused deposition modeling (FDM) or fused filament fabrication (FFF). Wire 3D printing can comprise electron beam freeform fabrication (EBF3). Granular 3D printing can comprise direct metal laser sintering (DMLS), electron beam melting (EBM), selective laser melting (SLM), selective heat sintering (SHS), or selective laser sintering (SLS). Power bed and inkjet head 3D printing can comprise plaster-based 3D printing (PP). Laminated 3D printing can comprise laminated object manufacturing (LOM). Light polymerized 3D printing can comprise stereo-lithography (SLA), digital light processing (DLP) or laminated object manufacturing (LOM).

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

### Methods for Forming 3D Objects by Direct Energy Deposition

The present disclosure provides methods and systems for forming a 3D object using direct energy deposition. Such deposition may be performed using a material feedstock (or build material) or multiple feedstocks. The feedstock may be a filament material. The filament material may be a composite filament. The deposition may be performed in the absence of extrusion.

A method for printing at least a portion of a three-dimensional (3D) object may comprise receiving, in computer memory, a model of the 3D object and subsequently directing at least one filament material (or feedstock) from a source of the at least one filament material towards a build platform configured to support the 3D object. This may deposit a first layer corresponding to a portion of the 3D object adjacent to the build platform in accordance with the model of the 3D object. Next, the at least one filament material may be used to deposit a second layer corresponding to at least a portion of the 3D object. The second layer may be deposited in accordance with the model of the 3D object. While the second layer may be deposited, at least a first energy beam from at least one energy source may be used to selectively heat a first portion of the first layer and a second portion of the at least one filament material. The first portion may be brought in contact with the second portion during heating or subsequent to heating. Such heating may soften, melt or liquefy the first portion and/or the second portion. The heating may be selective such that at most portions of the first layer and the at least one filament material are heated. This may be repeated for additional layers or portions of layers of the 3D object.

In another aspect, the present disclosure provides a system for printing at least a portion of a three-dimensional (3D) object. The system may comprise a source of at least one filament material, computer memory configured to receive a model of the 3D object, a least one energy source configured to provide at least one energy beam, and/or one or more computer processors operatively coupled to the computer memory and the at least one energy source. The one or more computer processors may be individually or collectively programmed to (i) direct the at least one filament material from the source of the at least one filament material towards a build platform configured to support the 3D object, thereby depositing a first layer corresponding to a portion of the 3D object adjacent to the build platform, which first layer is deposited in accordance with the model of the 3D object from the computer memory; (ii) direct the at least one filament material to deposit a second layer corresponding to the at least the portion of the 3D object, which second layer is deposited in accordance with the model of the 3D object; and (iii) while the second layer is being deposited, direct the at least one energy source to provide the at least one energy beam to selectively heat a first portion of the first layer and a second portion of the at least one filament material, which first portion is brought in contact with the second portion.

In another aspect, the present disclosure provides a system for printing at least a portion of a three-dimensional (3D) object. The system may comprise a source of at least one feedstock, computer memory configured to receive a model of the 3D object, and/or one or more computer processors operatively coupled to the computer memory. The one or more computer processors may be individually or collectively programmed to (i) direct use of the at least one feedstock from the source of the at least one feedstock to deposit a first layer adjacent to a build platform, which first layer is deposited in accordance with the model of the 3D object, (ii) direct use of the at least one feedstock from the source of the at least one feedstock to deposit a second layer adjacent to the first layer, which second layer is deposited in accordance with the model of the 3D object.

In some cases, depositing of the first layer corresponding to the at least the portion of the 3D object may be performed without heating of the at least one filament material.

In some cases, at least one additional filament material from a source of the at least one additional filament material may be used to deposit an adhesion layer adjacent to the build platform to support the 3D object. The at least one additional filament material may be the same as the at least one filament material. The at least one additional filament material may be different than the at least one filament material. The at least one adhesion layer may not be part of the 3D object.

In some cases, one or more additional layers may be deposited over the first layer and the second layer. As described in more detail elsewhere herein, layers may be compacted or compressed during or subsequent to deposition. For example, the first layer may be compacted or compressed during or subsequent to deposition of the first layer or during or subsequent to deposition of the second layer against the first layer. In some cases, the second layer may be compacted subsequent to heating the portion of the first layer and the second portion of the at least one filament material.

Feedstock usable by methods and systems of the present disclosure may be a filament having various form factors or geometric shapes, such as a cross-section that may be circular, oval, triangular, square, rectangular, pentagonal, hexagonal, heptagonal, octagonal, nonagonal, decagonal, star-shaped, or partial shapes or combinations of shapes thereof. The filament may not be a two-dimensional tape. The feedstock may be formed of a composite material, such as a material comprising one or more polymeric materials and one or more reinforcing materials. In some examples, the feedstock may comprise a polymer filament and a reinforcing filament interwoven or as a bundle. In some examples the at least one feedstock is not a tape.

In some embodiments, the at least one filament material is a bundle of filament materials. In some embodiments, the bundle of filament material comprises a polymeric material and a reinforcing material. In some embodiments, the filament material comprises one or more elements selected from the group consisting of continuous fiber, long fiber, short fiber, and milled fiber. In some embodiments, the filament material comprises one or more elements selected from the group consisting of carbon nanotube, graphene, Bucky ball(s), and metallic material (e.g., elemental metal or metal alloy).

The feedstock may have a cross sectional ratio of a first dimension to a second dimension (orthogonal to the first dimension), such as width to height, that may be greater than or equal to about 1:50, 1:40, 1:30, 1:20, 1:10, 1:5, 1:4, 1:3, 1:2.5, 1:2, 1:1.1, 1:1, 1.1:1, 2:1, 2.5:1, 3:1, 4:1, 5:1, 10:1, 20:1, 30:1, 40:1, 50:1, 100:1, 200:1, 300:1, 500:1, 1000:1, or more. The feedstock may have a cross sectional ratio of a first dimension to a second dimension (orthogonal to the first dimension), such as width to height, that may be less than or equal to about 1000:1, 500:1, 400:1, 300:1, 200:1, 100:1, 50:1, 40:1, 30:1, 20:1, 10:1, 5:1, 4:1, 3:1, 2.5:1, 2:1, 1.1:1, 1:1, 1:1.1, 1:2, 1:2.5, 1:3, 1:4, 1:5, 1:10, 1:20, 1:30, 1:40, 1:50, or less. The feedstock may have a cross sectional ratio of a first dimension to a second dimension (orthogonal to the first dimension) that may be from about 1000:1 to 1:50, 500:1 to 1:50, 100:1 to 1:50, 1:1 to 1:50, 1000:1 to 1:50, 500:1 to 1:50, 100:1 to 1:50, or 1:1 to 1:50. The feedstock may have a cross sectional ratio of a first dimension to a second dimension (orthogonal to the first dimension) that may be about 2.66:3, 1:2.66, or 1:3.

The feedstock may have a cross sectional ratio of the first dimension to the second dimension that may be greater than or equal to about 1:50, 1:40, 1:30, 1:20, 1:10, 1:5, 1:4, 1:3, 1:2, 1:1, 2:1, 3:1, 4:1, 5:1, 10:1, 20:1, 30:1, 40:1, 50:1, 100:1, 200:1, 300:1, 400:1, 500:1, 1000:1, or more. In some example, the first dimension is a width and the second dimension is a height along a given cross-section of the feedstock. The ratio may be greater than or equal to about 1:5, 1:4, 1:3, 1:2, 1:1, 2:1, 3:1, 4:1, 5:1, 6:1, 7:1, 8:1, 9:1, 10:1, or more. The ratio may be less than or equal to about 10:1, 9:1, 8:1, 7:1, 6:1, 5:1, 4:1, 3:1, 2:1, 1:1, 1:2, 1:3, 1:4, 1:5, or less. The ratio may be from about 10:1 to 1:5, 5:1 to 1:5, 1:1 to 1:5, 1:3 to 1:5, 10:1 to 1:1, 5:1 to 1:1, or 2:1 to 1:1. The ratio may be such that the feedstock may be symmetrical about a given plane. In other instance, the ratio may be such that the feedstock may not be symmetrical about a given plane. The ratio may be such that the feedstock is not tape or tape-like. The ratio may be from about 20:1 to 1:20, or 10:1 to 1:10, or 5:1 to 1:5, or 2:1 to 1:2, or 1.5:1 to 1:1.5. In some examples, a ratio of about 1:1 is for a feedstock with a circular or box-like cross-section.

During or subsequent to deposition, the deposited feedstock may be compressed or reshaped. This may be performed by applying heat using a non-contact energy source, such as an optical energy source (e.g., laser). The heat may soften, liquefy or melt the polymeric material (e.g., change viscosity). In some instances, amorphous polymers may not have a melting point and can alter in form to a lower viscosity with heat and can be liquids. In other instances, a polymer in solid state may be a super cooled liquid, such as a liquid with very high viscosity. Pressure may be applied to compress deposited layers, which may provide for improved adhesion of layers during formation of the 3D object. The deposition shape may be controlled based at least in part on an original shape of the feedstock, amount of pressure and/or temperature.

Reshaping of feedstock may have various benefits. For example, this may allow for printing of 3D objects or portions of 3D objects with sharp angles (e.g., 90 degree angles, 180 degree angles, etc.), which may not be possible using tape feedstock. Methods and systems of the present disclosure may permit improved interlayer bonding by applying heat to a previously deposited layer and a layer being deposited. This may provide a liquid-liquid interface, which may enable improved adhesion between layers.

Interlay bonding may be improved using a combination of materials as part of the feedstock. The feedstock may be a filament material. The filament material may be a composite filament. The feedstock may include one or more polymeric materials and one or more additional fibers. Various examples of the polymeric material are provided elsewhere herein. Such additional fibers may be reinforcing fibers. The one or more additional fibers may include carbon nanotubes, graphene, Bucky balls, metallic materials (e.g., steel), or a combination thereof. For example, the feedstock may incorporate carbon nanotubes and chopped fiber in a polymer matrix. In some cases, the polymer matrix in a composite feedstock may be a thermoplastic or a thermosetting polymer (thermoset).

The feedstock may comprise one or more polymeric materials and a continuous fiber, long fiber, chopped fiber, milled fiber, nanotube (e.g., carbon nanotube), Bucky Ball, graphene, or a combination thereof. The one or more polymeric materials may be in a polymer matrix. The fiber may be a reinforcing material. Such configuration may improve interlayer bonding. For example, the feedstock comprises a polymeric material and one or more of (i) a continuous fibers, (ii) nanotubes and (iii) chopped fibers. In some examples, the long fiber have lengths from about 30 millimeters (mm) to 100 mm, or 60 mm to 80 mm; the chopped fiber have lengths from about 10 mm to 50 mm, or 20 mm to 30 mm; and the milled fiber have lengths from about 0.5 mm to 5 mm, or 1 mm to 2 mm.

In some embodiments, the nanotubes may have a length that may be less than or equal to about 1000 nm, 900 nm, 800 nm, 700 nm, 600 nm, 500 nm, 400 nm, 300 nm, 200 nm, 100 nm, 50 nm, 25 nm, 10 nm, 1 nm, 0.1 nm, 0.01 nm, or less. In some embodiments, the nanotubes may have a length that may be greater than or equal to about 0.1 nm, 1 nm, 10 nm, 25 nm, 50 nm, 100 nm, 200 nm, 300 nm, 400 nm, 500 nm, 600 nm, 700 nm, 800 nm, 900 nm, 1000 nm, or more. In some embodiments, the nanotubes may have a length that may be from about 0.01 nm to 1000 nm, 0.01 nm to 900 nm, 0.01 nm to 800 nm, 0.01 nm to 700 nm, 0.01 nm to 600 nm, 0.01 nm to 500 nm, 0.01 nm to 400 nm, 0.01 nm to 300 nm, 0.01 nm to 200 nm, 0.01 nm to 100 nm, 0.01 nm to 25 nm, 0.01 nm to 10 nm, 0.01 nm to 1 nm, 0.01 nm to 0.1 nm, 1 nm to 1000 nm, 1 nm to 900 nm, 1 nm to 800 nm, 1 nm to 700 nm, 1 nm to 600 nm, 1 nm to 500 nm, 1 nm to 400 nm, 1 nm to 300 nm, 1 nm to 200 nm, 1 nm to 100 nm, 1 nm to 25 nm, 1 nm to 10 nm, 10 nm to 1000 nm, 10 nm to 900 nm, 10 nm to 800 nm, 10 nm to 700 nm, 10 nm to 600 nm, 10 nm to 500 nm, 10 nm to 400 nm, 10 nm to 300 nm, 10 nm to 200 nm, 10 nm to 100 nm, 10 nm to 25 nm, 25 nm to 1000 nm, 25 nm to 900 nm, 25 nm to 800 nm, 25 nm to 700 nm, 25 nm to 600 nm, 25 nm to 500 nm, 25 nm to 400 nm, 25 nm to 300 nm, 25 nm to 200 nm, 25 nm to 100 nm, 50 nm to 1000 nm, 50 nm to 900 nm, 50 nm to 800 nm, 50 nm to 700 nm, 50 nm to 600 nm, 50 nm to 500 nm, 50 nm to 400 nm, 50 nm to 300 nm, 50 nm to 200 nm, 50 nm to 100 nm, 100 nm to 1000 nm, 100 nm to 900 nm, 100 nm to 800 nm, 100 nm to 700 nm, 100 nm to 600 nm, 100 nm to 500 nm, 100 nm to 400 nm, 100 nm to 300 nm, 100 nm to 200 nm, 500 nm to 1000 nm, 500 nm to 900 nm, 500 nm to 800 nm, 500 nm to 700 nm, or 500 nm to 600 nm. In some embodiments, the nanotubes may have a length that may be about 100 nm.

In some embodiments, the chopped fibers may have a length that may be less than or equal to about 1000 nm, 900 nm, 800 nm, 700 nm, 600 nm, 500 nm, 400 nm, 300 nm, 200 nm, 100 nm, 50 nm, 25 nm, 10 nm, 1 nm, 0.1 nm, 0.01 nm, or less. In some embodiments, the chopped fibers may have a length that may be greater than or equal to about 0.1 nm, 1 nm, 10 nm, 25 nm, 50 nm, 100 nm, 200 nm, 300 nm, 400 nm, 500 nm, 600 nm, 700 nm, 800 nm, 900 nm, 1000 nm, or more. In some embodiments, the chopped fibers may have a length that may be from about 0.01 nm to 1000 nm, 0.01 nm to 900 nm, 0.01 nm to 800 nm, 0.01 nm to 700 nm, 0.01 nm to 600 nm, 0.01 nm to 500 nm, 0.01 nm to 400 nm, 0.01 nm to 300 nm, 0.01 nm to 200 nm, 0.01 nm to 100 nm, 0.01 nm to 25 nm, 0.01 nm to 10 nm, 0.01 nm to 1 nm, 0.01 nm to 0.1 nm, 1 nm to 1000 nm, 1 nm to 900 nm, 1 nm to 800 nm, 1 nm to 700 nm, 1 nm to 600 nm, 1 nm to 500 nm, 1 nm to 400 nm, 1 nm to 300 nm, 1 nm to 200 nm, 1 nm to 100 nm, 1 nm to 25 nm, 1 nm to 10 nm, 10 nm to 1000 nm, 10 nm to 900 nm, 10 nm to 800 nm, 10 nm to 700 nm, 10 nm to 600 nm, 10 nm to 500 nm, 10 nm to 400 nm, 10 nm to 300 nm, 10 nm to 200 nm, 10 nm to 100 nm, 10 nm to 25 nm, 25 nm to 1000 nm, 25 nm to 900 nm, 25 nm to 800 nm, 25 nm to 700 nm, 25 nm to 600 nm, 25 nm to 500 nm, 25 nm to 400 nm, 25 nm to 300 nm, 25 nm to 200 nm, 25 nm to 100 nm, 50 nm to 1000 nm, 50 nm to 900 nm, 50 nm to 800 nm, 50 nm to 700 nm, 50 nm to 600 nm, 50 nm to 500 nm, 50 nm to 400 nm, 50 nm to 300 nm, 50 nm to 200 nm, 50 nm to 100 nm, 100 nm to 1000 nm, 100 nm to 900 nm, 100 nm to 800 nm, 100 nm to 700 nm, 100 nm to 600 nm, 100 nm to 500 nm, 100 nm to 400 nm, 100 nm to 300 nm, 100 nm to 200 nm, 500 nm to 1000 nm, 500 nm to 900 nm, 500 nm to 800 nm, 500 nm to 700 nm, or 500 nm to 600 nm. In some embodiments, the chopped fibers may have a length that may be about 100 nm.

The feedstock may be single filament feedstock or multi-filament feedstock. The feedstock may include one or more polymeric materials and one or more reinforcing materials, as described elsewhere herein. A cross-sectional dimension (e.g., diameter in the case of feedstock with circular cross-sections) of the feedstock may be greater than or equal to about 0.1 mm, 0.2 mm, 0.3 mm, 0.4 mm, 0.5 mm, 1 mm, 2 mm, 3 mm, 4 mm, 5 mm, 10 mm, 20 mm, or more. A cross-sectional dimension (e.g., diameter in the case of feedstock with circular cross-sections) of the feedstock may be less than or equal to about 20 millimeters (mm), about 10 mm, about 5 mm, about 4 mm, about 3 mm, about 2 mm, about 1 mm, about 0.9 mm, about 0.8 mm, about 0.7 mm, about 0.6 mm, about 0.5 mm, about 0.4 mm, about 0.3 mm, about 0.2 mm, about 0.1 mm, or less. The diameter may be from about 0.1 mm to 10 mm, 0.2 mm to 5 mm, 0.3 mm to 4 mm, 0.4 mm to 3 mm, or 0.5 mm to 2 mm.

The one or more polymeric materials may include a thermoplastic. The one or more polymeric materials may include a thermoset.

Three-dimensional printing may be performed using various materials. The form of the build materials that may be used in embodiments of the present disclosure include, without limitation, filaments, sheets, powders, and inks. In some examples, a material that may be used in 3D printing includes a polymeric material, elemental metal, metal alloy, a ceramic, composite material, an allotrope of elemental carbon, or a combination thereof. The allotrope of elemental carbon may comprise amorphous carbon, graphite, graphene, diamond, or fullerene. The fullerene may be selected from the group consisting of a spherical, elliptical, linear, tubular fullerene, and any combination thereof. The fullerene may comprise a Bucky ball or a carbon nanotube. The material may comprise an organic material, for example, a polymer or a resin. The material may comprise a solid or a liquid. The material may include one or more strands or filaments. The solid material may comprise powder material. The powder material may be coated by a coating (e.g., organic coating such as the organic material (e.g., plastic coating)). The powder material may comprise sand. The material may be in the form of a powder, wire, pellet, or bead. The material may have one or more layers. The material may comprise at least two materials. In some cases, the material includes a reinforcing material (e.g., that forms a fiber). The reinforcing material may comprise a carbon fiber, Kevlar®, Twaron®, ultra-high-molecular-weight polyethylene, or glass fiber.

Prior to printing the part or object, a computer aided design (CAD) model may be optimized based on specified requirements. For example, the CAD model may comprise a geometry “envelop”. A geometry envelop may be an initial shell design of the three-dimensional part comprising design requirements and geometric features. The geometry of the CAD model may be received by way of I/O devices. Design requirements may be selected from the group consisting of strength, structural deflections, stress, strain, tension, shear, load capacity, stiffness, factor-of safety, weight, strength to weight ratio, envelop geometry, minimal print time, thermal performance, electrical performance, porosity, infill, number of shells, layer height, printing temperature, print head or nozzle temperature, solid density, melt density, printing speed, print head movement speed, and any combination thereof.

The CAD model may be initially partitioned according to user input and built in tool path generator rules to produce numerical control programming codes of the partitioned computer model. Partitioning may generate one or more parameters for printing the part. The one or more parameters may be selected from the group consisting of filament diameter, layer thickness, infill percentage, infill pattern, raster angle, build orientation, printed material width, feedstock or deposition material width, layer height, shell number, infill overlap, grid spacing, and any combination thereof. Partitioning may also generate one or more numerical control programming code of the partitioned computer model. The numerical control programming code can comprise G-code files and intermediate files. G-code files may be a numerical control programming language and can be used in computer-aided manufacturing as a way of controlling automated machine tools. The actions controlled by the G-code may comprise rapid movement, controlled feed in an arc or straight line, series of controlled feed movements, switch coordinate systems, and a set of tool information. Intermediate files may comprise supplemental files and tools for a primary build output. Additionally, intermediate files can comprise automatically generated source files or build output from helper tools. The information from the G-code files and the intermediate files may be extracted to determine the geometry of the three-dimensional printed part.

The 3D object may have a 3D solid model created in CAD software. Such 3D object can be sliced using conventional algorithms as are known in the art to generate a series of two dimensional (2D) or 3D layers representing individual transverse cross sections of the 3D object, which collectively depict the 3D object. The 2D slice information for the layers may be sent to the controller and stored in memory. Such information can control the process of fusing particles into a dense layer according to the modeling and inputs obtained during the build process.

Prior to printing the three-dimensional object, a model, in computer memory, of the part for three-dimensional printing may be received from a material. The material can comprise a matrix and fiber material. Additionally, in computer memory, one or more properties for the material may be received. Using the model, a print head tool path may be determined for use during the three-dimensional printing of the part. A virtual mesh of analytic elements may be generated within the model of the part and a trajectory of at least one stiffness-contributing portion of the material may be determined based at least in part on the print head tool path, wherein the trajectory of the at least one stiffness-contributing portion may be determined through each of the analytic elements in the virtual mesh. Next, one or more computer processors may be used to determine a performance of the part based at least in part on the one or more properties received and the trajectory of the at least one stiffness-contributing portion. The performance of the part may be electronically outputted. The three-dimensional object may then be printed along the print head tool path.

The present disclosure may provide ways to improve the mechanical, thermal, and electrical properties of additively manufactured parts. All additive manufacturing approaches build up an object in a layer-by-layer fashion. In other words, the layers of build material are deposited one on top of the next, such that a successive layer of build material may be deposited upon a previously deposited/constructed layer that has cooled below its melting temperature. The print head may comprise three or more axes or degrees of freedom so that the print head can move in the +X direction, the −X direction, the +Y direction, the −Y direction, the +Z direction, the −Z direction, or any combination thereof. The print head may be configured as a six-axis robotic arm. Alternatively, the print head may be configured as a seven-axis robotic arm. The print head may be placed at any location in the build volume of the 3D object, from any approach angle.

The present disclosure may provide a system for additive manufacturing processes that may provide localized heating to create a “melt pool” in the current layer or segment of deposited build material prior to depositing the next segment or layer. The melt pool may span the entire thickness of the printed segment, thereby increasing the adhesion across segments built in the same layer. The melt pool can span a portion of the thickness of the printed segment. The melt pool may increase the diffusion and mixing of the build material between adjacent layers (across the Z direction) as compared to current methods, which deposit a subsequent layer of build material on top of a layer of build material that may be below its melting temperature. The increased diffusion and mixing resulting from the melt pool can increase the chemical chain linkage/bonding and chemical chain interactions between the two layers. This can result in increases in the build-material adhesion in the Z direction, thereby enhancing mechanical, thermal, and electrical properties. The melt pool may also reduce void space and porosity in the build object. Among any other benefits, this decrease in porosity also contributes somewhat to the aforementioned improvement in mechanical, thermal, and electrical properties. Furthermore, the use of carbon nanotubes and graphene may further improve melt pool formation by absorbing energy, such as laser energy, and may convert it into heat that may enhance the melting process.

Before depositing a layer of material on an underlying layer in a build object, the portion of the underlying layer on which the subsequent layer may be deposited to may be melted, creating a “melt pool.” The melt pool may be created using an energy source, such as, without limitation, by a laser, a microwave source, a resistive heating source, an infrared energy source, a UV energy source, hot fluid, a chemical reaction, a plasma source, a microwave source, an electromagnetic source, or an electron beam. Resistive heating may be joule heating. A source for resistive heating may be a power supply. The applied energy may primarily be a function of the chemical composition of the build material, such as the build material's thermal conductivity, heat capacity, latent heat of fusion, melting point, and melt flow viscosity.

Prior to printing the 3D object, a request for production of a requested 3D object may be received from a customer. The method may comprise packaging the three dimensional object. After printing of the 3D object, the printed three dimensional object may be delivered to the customer.

The layered structure may comprise substantially repetitive layers. The layers may have an average layer size that may be greater than or equal to about 0.5 micrometer (μm), 1 μm, 5 μm, 10 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm, 450 μm, 500 μm, 1 mm, 2 mm, 3 mm, 5 mm, 10 mm, 50 mm, 100 mm, 500 mm, or more. The layers may have an average layer size that may be less than or equal to about 500 mm, 100 mm, 50 mm, 10 mm, 5 mm, 4 mm, 3 mm, 2 mm, 1 mm, 500 μm, 450 μm, 400 μm, 350 μm, 300 μm, 250 μm, 200 μm, 150 μm, 100 μm, 90 μm, 80 μm, 70 μm, 60 μm, 50 μm, 40 μm, 30 μm, 20 μm, 10 μm, 5 μm, 1 μm, or less. The layers may have an average layer size of any value between the aforementioned values of layer size. For example, the substantially repetitive microstructure may have an average layer size from about 0.5 μm to about 500 mm, from about 0.5 μm to about 100 mm, from about 0.5 μm to about 50 mm, from about 0.5 μm to about 10 mm, from about 0.5 μm to about 1 mm, from about 0.5 μm to about 500 μm, from about 0.5 μm to about 250 μm, from about 0.5 μm to about 50 μm, from about 0.5 μm to about 10 μm, from about 50 μm to about 500 mm, from about 50 μm to about 100 mm, from about 50 μm to about 50 mm, from about 50 μm to about 10 mm, from about 50 μm to about 1 mm, from about 50 μm to about 500 μm, from about 50 μm to about 250 μm, from about 50 μm to about 100 μm, from about 250 μm to about 500 mm, from about 250 μm to about 100 mm, from about 250 μm to about 50 mm, from about 250 μm to about 10 mm, from about 250 μm to about 1 mm, from about 250 μm to about 500 μm, from about 500 μm to about 500 mm, from about 500 μm to about 100 mm, from about 500 μm to about 50 mm, from about 500 μm to about 10 mm, from about 500 μm to about 1 mm, from about 1 mm to about 500 mm, from about 1 mm to about 100 mm, from about 1 mm to about 50 mm, from about 1 mm to about 10 mm, from about 5 mm to about 500 mm, from about 5 mm to about 100 mm, from about 5 mm to about 50 mm, from about 5 mm to about 10 mm, from about 15 μm to about 100 μm, from about 5 μm to about 300 μm, from about 20 μm to about 90 μm, or from about 10 μm to about 70 μm. The layered structure can be indicative of layered deposition. The layered structure may be indicative of solidification of melt pools formed during a three dimensional printing process, such as by selective energy melting. The structure indicative of a three dimensional printing process may comprise substantially repetitive variation comprising: variation in grain orientation, variation in material density, variation in the degree of compound segregation to grain boundaries, variation in the degree of element segregation to grain boundaries, variation in material phase, variation in metallurgical phase, variation in material porosity, variation in crystal phase, or variation in crystal structure.

The source of at least one filament material may be configured to supply at least one filament material for generating the three-dimensional object. The at least one filament material may be a composite material, such as a continuous fiber composite. The filament material may comprise one or elements selected from the group consisting of nano milled fiber, short fiber, long fiber, continuous fiber, or a combination thereof. The continuous fiber composite may be a continuous core reinforced filament. The at least one filament may include the continuous core reinforced filament and a polymer that may coat or impregnate an internal continuous core. Depending upon the particular embodiment, the core may be a solid core or it may be a multi-strand core comprising multiple strands. The continuous fiber composite may be selected from the group consisting of glass, carbon, aramid, cotton, silicon carbide, polymer, wool, metal, and any combination thereof.

The filament material may incorporate one or more additional materials, such as resins and polymers. For example, appropriate resins and polymers include, but may not limited to, acrylonitrile butadiene styrene (ABS), epoxy, vinyl, nylon, polyetherimide (PEI), Polyaryletherketone (PAEK), Polyether ether ketone (PEEK), Polyactic Acid (PLA), Liquid Crystal Polymer, polyamide, polyimide, polyphenylene sulfide, polyphenylsulfone, polysulfone, polyether sulfone, polyethylenimine, polytetrafluoroethylene, polyvinylidene, and various other thermoplastics. If used, the core of the continuous fiber composite may be selected to provide any desired property. Appropriate core fiber or strands may include those materials which impart a desired property, such as structural, conductive (electrically and/or thermally), insulative (electrically and/or thermally), optical and/or fluidic transport. Such materials may include, but may be not limited to, carbon fibers, ararmid fibers, fiberglass, metals (such as copper, silver, gold, tin, iron, aluminum, lead, zinc, platinum, nickel, cobalt, titanium, and steel), optical fibers, and flexible tubes. The core fiber or strands may be provided in any appropriate size. Further, multiple types of continuous cores may be used in a single continuous core reinforced filament to provide multiple functionalities such as electrical and optical properties. A single material may be used to provide multiple properties for the core reinforced filament. For example, a steel core may be used to provide both structural properties as well as electrical conductivity properties.

The strand material may be used in place of or in addition to flat tape to adhere the printed object to the build plate and/or base. Tape such as kapton or painter's tape may be used to adhere a printed object to the build plate and/or base but may suffer from limitations, such as warping, difficulty in applying to a build plate, and limited ability in adhering to printed objects that have curves. Strand materials may allow for greater adhesion between the build plate or base and the printed object, as well as permitting printing a part of a portion of the part having a shape (e.g., curved shape) that a standard tape may not permit. Stronger adhesion between build plate and printed object may reduce or eliminate warping between the printed object and build plate and/or base. This may allow for variation of aspect ratios and interlayering in a printed object that may not be obtained using a flat tape alone. Variation in aspect ratios and interlayering may allow for expanded design choice and flexibility in modeling and creating more complex printed objects.

Feedstock for 3D printing may be formed of a plurality of filaments, such as at least 2, 3, 5, 7, 10, 100, 200, 300, 400, 500, 1000, 10000, 100000, 1000000, or more. Feedstock for 3D printing may be formed of a plurality of filaments, such as at most 1000000, 100000, 10000, 1000, 500, 400, 300, 200, 100, 10, 7, 5, 3, or 2 filaments. The feedstock may be formed of a single filament. Feedstock for 3D printing may be formed of a plurality of filaments, such as from 2 to 1000000, 2 to 10000, 2 to 1000, 2 to 500, 2 to 100, 2 to 5, 2 to 3, 10 to 1000000, 10 to 100000, 10 to 1000, 10 to 500, 10 to 100, 100 to 1000000, 100 to 10000, 100 to 1000, 100 to 500, 100 to 200, 1000 to 1000000, 1000 to 100000, or 100000 to 1000000 filaments. The feedstock may be formed of different types of filaments, such as formed of a polymeric material and a second filament formed of a reinforcing material. The polymeric material may be a thermosetting polymer. In some examples, the polymeric material is selected from polyaryletherketone (PAEK), polyetheretherketone (PEEK), polyetherketoneketone (PEKK), polyethylene (PE), polyetherimide (PEI commonly known as Ultem), polyethersulfone (PES), polysulfone (PSU commonly known as Udel), polyphenylsulfone (PPSU commonly known as Radel), polyphenylene oxides (PPOs), acrylonitrile butadiene styrene (ABS), polylactic acid (PLA), polyglycolic acid (PGA), polyamide-imide (PAI commonly known as Torlon), polystyrene (PS), polyamide (PA), polybutylene terephthalate (PBT), poly(p-phenylene sulfide) (PPS), polyethersulfone (PESU), polyphenylene ether (commonly known as PrimoSpire), and polycarbonate (PC). The reinforcing material may be a carbon-based material, such as carbon nanotubes, graphene, Bucky balls, metallic materials (e.g., steel), or a combination thereof.

The filaments of the feedstock may be interwoven. In some cases, at least 1, 2, 3, 5, 7, 10, 100, 200, 300, 400, 500, 1000, 10000, 100000, 1000000, or more filaments may be interwoven (in the case of one filament, for example, the filament may be folded onto itself). In some cases, at most 1000000, 100000, 10000, 1000, 500, 400, 300, 200, 100, 10, 7, 5, 3, 2, or 1 filament may be interwoven (in the case of one filament, for example, the filament may be folded onto itself). In some cases, from 1 to 1000000, from 1 to 100000, from 1 to 10000, from 1 to 1000, from 1 to 100, from 1 to 10, from 2 to 1000000, 2 to 10000, 2 to 1000, 2 to 500, 2 to 100, 2 to 5, 2 to 3, 10 to 1000000, 10 to 100000, 10 to 1000, 10 to 500, 10 to 100, 100 to 1000000, 100 to 10000, 100 to 1000, 100 to 500, 100 to 200, 1000 to 1000000, 1000 to 100000, or 100000 to 1000000 may be interwoven. A sheath may be provided to retain the filaments and prevent contamination.

Alternatively, the filament material may comprise metal particles infused into a binder matrix. The metal particles may be metal powder. The binder matrix may include resins or polymers. Additionally, such binder matrix may be used a delivery device for the metal particles. Once the filament material may be deposited onto the base, one or more energy sources may heat and melt the binder matrix, leaving the metal particles to melt and fuse into larger metal particles. Such energy sources may be without limitation, by a laser, a microwave source, a resistive heating source, an infrared energy source, a UV energy source, hot fluid, a chemical reaction, a plasma source, a microwave source, an electromagnetic source, or an electron beam. Resistive heating may be joule heating. A source for resistive heating may be a power supply. The at least one filament material may be a metal filament. The at least one filament material may be a metal filament composite. The deposited at least one filament material may be subjected to resistive heating upon flow of an electrical current through the at least one filament material. The resistive heating may be sufficient to melt at least a portion of the deposited at least one filament material. The at least one filament material may be an electrode. The substrate may be another electrode.

The one or more energy sources may also provide localized heating to create a “melt pool” in the current layer or segment of the deposited build material prior to depositing the next segment or layer. The melt pool may be generated using a power source that may be greater than or equal to about 1 microwatt (μW), 10 μW, 100 μW, 1 millimiwatt (mW), 10 mW 100 mW, 1 watt (W), 10 W, 20 W, 30 W, 50 W, 100 W, 200 W, 500 W, 1 kilowatt (kW), 10 kW, 100 kW, 1000 kilowatt (kW), or more. The melt pool may be generated using a power source that may be less than or equal to about 1000 kW, 100 kW, 10 kW, 1 kW, 500 W, 200 μW, 100 W, 50 W, 30 W, 20 W, 10 W, 1 W, 100 mW, 10 mW, 1 mW, 100 μW, 10 μW, 1 μW, or less. The melt pool may be generated using a power source that may be from about 1 μW to 1000 kW, from about 1 μW to about 100 kW, from about 1 μW to about 10 kW, from about 1 μW to about 500 W, from about 1 μW to about 100 W, from about 1 μW to about 1 W, from about 1 μW to about 100 mW, from about 1 μW to about 10 mW, from about 1 μW to about 1 mW, from about 1 μW to about 100 μW, from about 1 μW to about 10 μW; from about 1 mW to about 1000 kW, from about 1 mW to about 100 kW, from about 1 mW to about 10 kW, from about 1 mW to about 1 kW, from about 1 mW to about 500 W, from about 1 mW to about 100 W, from about 1 mW to about 10 W, from about 1 mW to about 1 W, from about 1 mW to about 100 mW, from about 1 mW to about 10 mW, from about 1 W to about 1000 kW, from about 1 W to about 100 kW, from about 1 W to about 10 kW, from about 1 W to about 1 kW, from about 1 W to about 100 W, from about W to about 10 W, from about 10 W to about 1000 kW, from about 10 W to about 100 kW, from about 10 W to about 10 kW; from about 10 W to about 1 kW, from about 10 W to about 100 W, from about 100 W to about 1000 kW, from about 100 W to about 100 kW, from about 100 W to about 10 kW, or from about 100 W to about 1 kW. The range may be from about 250 W to 700 W.

The melt pool may increase diffusion and mixing of the build material between adjacent layers (e.g., across a direction orthogonal to the layers) as compared to other methods which may deposit a subsequent layer of build material on top of a layer of build material that may be below its melting temperature. The diffusion of the build material between adjacent levels may be at greater than or equal to about 0.0001 millimeter squared per second (mm²/s), 0.001 mm²/s, 0.01 mm²/s, 0.1 mm²/s, 1 mm²/s, 10 mm²/s, 100 mm²/s, 1000 mm²/s, 10000 mm²/s, 100000 mm²/s, or more. The diffusion of the build material between adjacent levels may be at most 100000 mm²/s, 10000 mm²/s, 1000 mm²/s, 100 mm²/s, 10 mm²/s, 1 mm²/s, 0.1 mm²/s, 0.01 mm²/s, 0.001 mm²/s, 0.0001 mm²/s, or less. The diffusion of the build material between adjacent levels may be from about 0.0001 mm²/s to 100000 mm²/s, about 0.0001 mm²/s to 10000 mm²/s, about 0.0001 mm²/s to 1000 mm²/s, about 0.0001 mm²/s to 100 mm²/s, about 0.0001 mm²/s to 10 mm²/s, about 0.0001 mm²/s to 1 mm²/s, about 0.0001 mm²/s to 1 mm²/s, about 0.0001 mm²/s to 0.1 mm²/s, about 0.0001 mm²/s to 0.01 mm²/s, about 0.0001 mm²/s to 0.01 mm²/s, about 0.0001 mm²/s to 0.001 mm²/s, from about 0.01 mm²/s to 100000 mm²/s, about 0.01 mm²/s to 10000 mm²/s, about 0.01 mm²/s to 1000 mm²/s, about 0.01 mm²/s to 100 mm²/s, about 0.01 mm²/s to 10 mm²/s, about 0.01 mm²/s to 1 mm²/s, about 0.01 mm²/s to 1 mm²/s, about 0.01 mm²/s to 0.1 mm²/s, from about 1 mm²/s to 100000 mm²/s, about 1 mm²/s to 10000 mm²/s, about 1 mm²/s to 1000 mm²/s, about 1 mm²/s to 100 mm²/s, about 1 mm²/s to 10 mm²/s, from about 100 mm²/s to 100000 mm²/s, about 100 mm²/s to 10000 mm²/s, or about 100 mm²/s to 1000 mm²/s.

The melt pool may increase the reptation time of the build material between adjacent layers (e.g., across a direction orthogonal to the layers) as compared to other methods which may deposit a subsequent layer of build material on top of a layer of build material that may be below its melting temperature. The reptation time of the build material between adjacent levels may be at greater than or equal to about 0.001 seconds (s), 0.01 s, 0.02 s, 0.03 s, 0.04 s, 0.05 s, 0.06 s, 0.07 s, 0.08 s, 0.09 s, 0.1 s, 0.15 s, 0.2 s, 0.25 s, 0.3 s, 0.35 s, 0.4 s, 0.45 s, 0.5 s, 0.55 s, 0.6 s, 0.65 s, 0.7 s, 0.75 s, 0.8 s, 0.85 s, 0.9 s, 0.95 s, 1 s, 2 s, 3 s, 4 s, 5 s, 6 s, 7 s, 8 s, 9 s, 10 s, 20 s, 30 s, 60 s, or more. The reptation time of the build material between adjacent levels may be at less than or equal to about 60 s, 50 s, 40 s, 30 s, 20 s, 10 s, 9 s, 8 s, 7 s, 6 s, 5 s, 4 s, 3 s, 2 s, 1 s, 0.95 s, 0.9 s, 0.85 s, 0.8 s, 0.75 s, 0.7 s, 0.65 s, 0.6 s, 0.55 s, 0.5 s, 0.45 s, 0.4 s, 0.35 s, 0.3 s, 0.25 s, 0.2 s, 0.15 s, 0.1 s, 0.09 s, 0.08 s, 0.07 s, 0.06 s, 0.05 s, 0.04 s, 0.03 s, 0.02 s, 0.01 s, 0.001 s, or less. The reptation time of the build material between adjacent levels may be from about 0.001 s to 60 s, 0.001 s to 30 s, 0.001 s to 20 s, 0.001 s to 10 s, 0.001 s to 9 s, 0.001 s to 8 s, 0.001 s to 7 s, 0.001 s to 6 s, 0.001 s to 5 s, 0.001 s to 4 s, 0.001 s to 3 s, 0.001 s to 2 s, 0.001 s to 1 s, 0.001 s to 0.9 s, 0.001 s to 0.8 s, 0.001 s to 0.7 s, 0.001 s to 0.6 s, 0.001 s to 0.5 s, 0.001 s to 0.4 s, 0.001 s to 0.3 s, 0.001 s to 0.2 s, 0.001 s to 0.1 s, 0.001 s to 0.09 s, 0.001 s to 0.08 s, 0.001 s to 0.07 s, 0.001 s to 0.06 s, 0.001 s to 0.05 s, 0.001 s to 0.04 s, 0.001 s to 0.03 s, 0.001 s to 0.02 s, 0.001 s to 0.01 s, 0.01 s to 60 s, 0.01 s to 30 s, 0.01 s to 20 s, 0.01 s to 10 s, 0.01 s to 9 s, 0.01 s to 8 s, 0.01 s to 7 s, 0.01 s to 6 s, 0.01 s to 5 s, 0.01 s to 4 s, 0.01 s to 3 s, 0.01 s to 2 s, 0.01 s to 1 s, 0.01 s to 0.9 s, 0.01 s to 0.8 s, 0.01 s to 0.7 s, 0.01 s to 0.6 s, 0.01 s to 0.5 s, 0.01 s to 0.4 s, 0.01 s to 0.3 s, 0.01 s to 0.2 s, 0.01 s to 0.1 s, 0.01 s to 0.09 s, 0.01 s to 0.08 s, 0.01 s to 0.07 s, 0.01 s to 0.06 s, 0.01 s to 0.05 s, 0.01 s to 0.04 s, 0.01 s to 0.03 s, 0.01 s to 0.02 s 0.1 s to 60 s, 0.1 s to 30 s, 0.1 s to 20 s, 0.1 s to 10 s, 0.1 s to 9 s, 0.1 s to 8 s, 0.1 s to 7 s, 0.1 s to 6 s, 0.1 s to s, 0.1 s to 4 s, 0.1 s to 3 s, 0.1 s to 2 s, 0.1 s to 1 s, 0.1 s to 0.9 s, 0.1 s to 0.8 s, 0.1 s to 0.7 s, 0.1 s to 0.6 s, 0.1 s to 0.5 s, 0.1 s to 0.4 s, 0.1 s to 0.3 s, 0.1 s to 0.2 s, 1 s to 60 s, 1 s to 30 s, 1 s to 20 s, 1 s to 10 s, 1 s to 9 s, 1 s to 8 s, 1 s to 7 s, 1 s to 6 s, 1 s to 5 s, 1 s to 4 s, 1 s to 3 s, or 1 s to 2 s.

An energy source may be a source of optical energy (e.g., laser), convective fluid (e.g., hot air), or resistive heating. One or more different sources of energy may be used (e.g., combination of a laser and hot air).

Adhesion between filament that may be deposited and the previously deposited layer may be an integral part of building a void free and structurally strong three dimensional printed object. Heating of both filament and previously deposited layer may provide suitable adhesion as the filament may be being deposited on the previously deposited layer or other support and approaches the compaction roller. As the filament may be heated by the energy source, the viscosity of the filament may be decreased and the filament may be liquefied or at least partially liquefied. Heating may soften at least a portion or the entire filament. Simultaneously or substantially simultaneously, the energy source may also heat the previously deposited layer (or other support). In such circumstance, a liquid-liquid interface may form between the filament and the previously deposited layer (or other support) near the compaction roller. This decreased viscosity in the filament may result in greater adhesion to the previously deposited layer as the liquid-liquid interface of the filament-deposited layer mixes more freely as energy may be added to the system and may be compressed by the compaction roller. A higher degree of mixing may result in stronger bonding between the two materials and enhanced mechanical, thermal or electrical properties of the final printed object. Simultaneous or substantially simultaneous energy source heating of the filament and previously deposited layer may lead to printing in an open environment outside of a laboratory, as this heating may mitigate problems of fast cooling and potentially diminished structural integrity.

The increased diffusion and mixing that may result from the melt pool may increase the chemical chain linkage, bonding, and chemical chain interactions between the two layers. This may result in increasing the build-material adhesion in the Z direction, thereby enhancing mechanical, thermal, and electrical properties of the three-dimensional object. The melt pool may also reduce the void space and porosity in the build object. Among other benefits, this decrease in porosity may also contribute to the aforementioned improvement in mechanical, thermal, and electrical properties.

The at least one filament material may have a cross sectional shape selected from the group consisting of circle, ellipse, parabola, hyperbola, convex polygon, concave polygon, cyclic polygon, equilateral polygon, equiangular polygon, regular convex polygon, regular star polygon, tape-like geometry, and any combination thereof. Such filament material can have a diameter may be greater than equal to about 0.1 mm, 0.2 mm, 0.3 mm, 0.4 mm, 0.5 mm, 1 mm, 2 mm, 3 mm, 4 mm, 5 mm, 10 mm, 20 mm, or more. Such filament material can have a diameter that may be less than or equal to about 20 mm, 10 mm, 5 mm, 4 mm, 3 mm, 2 mm, 1 mm, 0.9 mm, 0.8 mm, 0.7 mm, 0.8 mm, 0.7 mm, 0.6 mm, 0.5 mm, 0.4 mm, 0.3 mm, 0.2 mm, 0.1 mm, or less. The diameter may be from about 0.1 mm to 10 mm, 0.2 mm to 5 mm, 0.3 mm to 4 mm, 0.4 mm to 3 mm, or 0.5 mm to 2 mm. The diameter may be from about 0.1 mm to 20 mm, from about 0.1 mm to 10 mm, 0.1 mm to 5 mm, from about 0.1 mm to 1 mm, from about 0.1 mm to 0.5 mm, from about 0.1 mm to 0.2 mm, from about 1 mm to 20 mm, from about 1 mm to 10 mm, 1 mm to 5 mm, 1 mm to 2 mm, from about 5 mm to 20 mm, or from about 5 mm to 10 mm.

Various modifiers within the layers themselves may be used which are selectively printed onto specific regions of the 3D object in order to impart various desirable mechanical, chemical, magnetic, electrical or other properties to the 3D object. Such modifiers may be selected from the group consisting of thermal conductors and insulators, dielectric promoters, electrical conductors and insulators, locally-contained heater traces for multi-zone temperature control, batteries, and sensors. In sonic embodiments, at least one print head may be used for printing such modifiers. As desired, such modifiers may be printed before at least a first energy beam may be directed onto at least a portion of the first layer and/or second layer. Alternatively, such modifiers may be printed over a layer that has been melted, before filament material for the next layer may be deposited.

For example, when printing a polyimide part from commercially available a filament comprising polyimide, an array of electrically conductive traces may be assimilated as an antenna to selectively absorb radiofrequency (RF) radiation within a specific and predetermined frequency range. The 3D object CAD model and software may designate as a sub-part the layer(s) that may comprise the traces for modified properties (high electrical conductivity). Alternatively, if these portions of the layer entail different levels of energy for inducing fusion, compared to other regions having only the primary material, the CAD model and design of the 3D object may be adjusted accordingly.

After deposition of a first layer and/or a second layer of at least a portion of the 3D object, and before fusion may be induced, the filament material may be preheated to a temperature sufficient to reduce undesirable shrinkage and/or to minimize the laser energy needed to melt the next layer. For example, the preheating may be accomplished using the infrared heater attached to substrate or through other apparatuses of directing thermal energy within an enclosed space around the substrate. Alternatively, the preheating may be accomplished using energy beam melting by defocusing the energy beam and rapidly scanning it over the deposited first layer and or second layer of at least a portion of the 3D object.

In some embodiments, at least a one energy beam from at least one energy source may be used to selectively heat and/or melt at least a portion of the first layer and/or the second layer, thereby forming at least a portion of the 3D object. The energy source may be selected from the group consisting of a laser, a microwave source, a resistive heating source, an infrared energy source, a UV energy source, hot fluid, a chemical reaction, a plasma source, a microwave source, an electromagnetic source, an electron beam, or any combination thereof. Resistive heating may be joule heating. A source for resistive heating may be a power supply. The at least one filament material may be a metal filament. The at least one filament material may be a metal filament composite. The deposited at least one filament material may be subjected to resistive heating upon flow of an electrical current through the at least one filament material. The resistive heating may be sufficient to melt at least a portion of the deposited at least one filament material. The at least one filament material may be an electrode. The substrate may be another electrode.

The energy source may be a function of the chemical composition of the build material, such as the build material's thermal conductivity, heat capacity, latent heat of fusion, melting point, and melt flow viscosity. The at least one energy source may be a laser. The laser may be selected from the group consisting of gas lasers, chemical lasers, dye lasers, metal-vapor lasers, solid-state lasers, semiconductor lasers, free electron laser, gas dynamic laser, nickel-like samarium laser, Raman laser, nuclear pump laser, and any combination thereof. Gas lasers may comprise one or more of helium-neon laser, argon laser, krypton laser, xenon ion laser, nitrogen laser, carbon dioxide laser, carbon monoxide laser, and excimer laser. Chemical lasers may be selected from the group consisting of hydrogen fluoride laser, deuterium fluoride laser, chemical oxygen-iodine laser, all gas-phase iodine laser, and any combination thereof. Metal-vapor lasers can comprise one or more of helium-cadmium, helium mercury, helium selenium, helium silver, strontium vapor laser, neon-copper, copper vapor laser, gold vapor laser, and manganese vapor laser. Solid-state lasers may be selected from the group consisting of ruby laser, neodymium-doped yttrium aluminium garnet laser, neodymium and chromium-doped yttrium aluminium garnet laser, erbium-doped yttrium aluminium garnet laser, neodymium-doped yttrium lithium fluoride laser, neodymium doped yttrium othovanadate laser, neodymium doped yttrium calcium oxoborate laser, neodymium glass laser, titanium sapphire laser, thulium yttrium aluminium garnet laser, ytterbium yttrium aluminium garnet laser, ytterbium:₂O₃ (glass or ceramics) laser, ytterbium doped glass laser (rod, plate/chip, and fiber), holmium yttrium aluminium garnet laser, chromium zinc selenium laser, cerium doped lithium strontium (or calcium) aluminum fluoride laser, Promethium 147 doped phosphate glass solid-state laser, chromium doped chrysoberyl (alexandrite) laser, erbium doped and erbium-ytterbium codoped glass lasers, trivalent uranium doped calcium fluoride solid-state laser, divalent samarium doped calcium fluoride laser, FARBE center laser, and any combination thereof. Semiconductor laser may comprise one or more of semiconductor laser diode laser, gallium nitride laser, indium gallium nitride laser, aluminum gallium indium phosphide laser, aluminum gallium arsenide laser, indium gallium arsenide phosphide laser, lead salt laser, vertical cavity surface emitting laser, quantum cascade laser, and hybrid silicon laser.

The melting temperature of the at least one filament material may be greater than or equal to about 25° C., 50° C., 100° C., 150° C., 200° C., 250° C., 300° C., 350° C., 400° C., 450° C., or more. The melting temperature of the at least one filament material may be less than or equal to about 450° C., 400° C., 350° C., 300° C., 250° C., 200° C., 150° C., 100° C., 50° C., 25° C., or less. The melting temperature of the at least one filament material may be from about 25° C. to 400, 25° C. to 350° C., 25° C. to 300° C., 25° C. to 250° C., 25° C. to 200° C., 25° C. to 150° C., 25° C. to 100° C., 25° C. to 50° C., 50° C. to 400, 50° C. to 350° C., 50° C. to 300° C., 50° C. to 250° C., 50° C. to 200° C., 50° C. to 150° C., 50° C. to 100° C., 100° C. to 450° C., 100° C. to 400° C., 100° C. to 350° C., 100° C. to 300° C., 100° C. to 250° C., 100° C. to 200° C., 100° C. to 150° C., 300° C. to 450° C., 300° C. to 400° C., or 300° C. to 350° C. The melting temperature of the at least one filament material may be from about 100° C. to 450° C. The melting temperature of the at least one filament material may be dependent on the material of the at least one filament.

The sintering temperature of the at least one filament material may be greater than equal to about 25° C., 50° C., 100° C., 150° C., 200° C., 250° C., 300° C., 350° C., 400° C., 450° C., or more. The sintering temperature of the at least one filament material can be less than or equal to about 450° C., 400° C., 350° C., 300° C., 250° C., 200° C., 150° C., 100° C., 50° C., 25° C., or less. The sintering temperature of the at least one filament material may be from about 25° C. to 400, 25° C. to 350° C., 25° C. to 300° C., 25° C. to 250° C., 25° C. to 200° C., 25° C. to 150° C., 25° C. to 100° C., 25° C. to 50° C., 50° C. to 400, 50° C. to 350° C., 50° C. to 300° C., 50° C. to 250° C., 50° C. to 200° C., 50° C. to 150° C., 50° C. to 100° C., 100° C. to 450° C., 100° C. to 400° C., 100° C. to 350° C., 100° C. to 300° C., 100° C. to 250° C., 100° C. to 200° C., 100° C. to 150° C., 300° C. to 450° C., 300° C. to 400° C., or 300° C. to 350° C. The sintering temperature of the at least one filament material may be dependent on the material of the at least one filament.

The method may further comprise separating the remainder of the layer that did not fuse and solidify to form at least a portion of the three dimensional object, from the portion. The sintering temperature of the at least one filament may be about similar to the flow temperature of the feedstock material.

The at least one energy beam from the energy source may be directed to the at least one portion of the 3D object adjacent to the substrate. Such energy beams may be sufficient to induce fusion of particles of the filament material within the desired cross-sectional geometry of the at least one portion of the 3D object. As the energy dissipates with cooling, atoms from neighboring particles may fuse together. In some embodiments, the at least one energy beam results in the fusion of particles of filament material both within the same layer and in the previously formed and resolidified adjoining layer(s) such that fusion may be induced between at least two adjacent layers of the part, such as between at least one filament material in a deposited unfused layer and a previously-fused adjacent layer. This process may be then repeated over multiple cycles as each part layer may be added, until the full 3D object may be formed.

In some cases, to create a melt pool large enough to span the width of the filament material segment, multiple energy sources or a combination of energy sources may be required. When multiple energy sources may be used, the energy sources may be the same energy source. Alternatively, the multiple energy sources may be different energy sources. The energy source(s) may be separate from the system for printing at least a portion of the 3D object. In some other embodiments, the energy source(s) may be integrated with such system. For example, in one embodiment, hot fluid may be channeled through the deposition nozzle. Because the material filament can flow in the melt pool, features of the 3D object being built may be altered. In some embodiments, the melt pool may be formed within the build object, such that a melt pool may be not formed near the perimeters thereof. To accomplish this, the energy source may be turned off when the perimeters of the object are being built. In such embodiments, the geometrical tolerance of the build object may be maintained while the interior of the object has enhanced interlayer bonding. During printing, the filament material may be printed in the X, Y, and Z directions in one segment or layer.

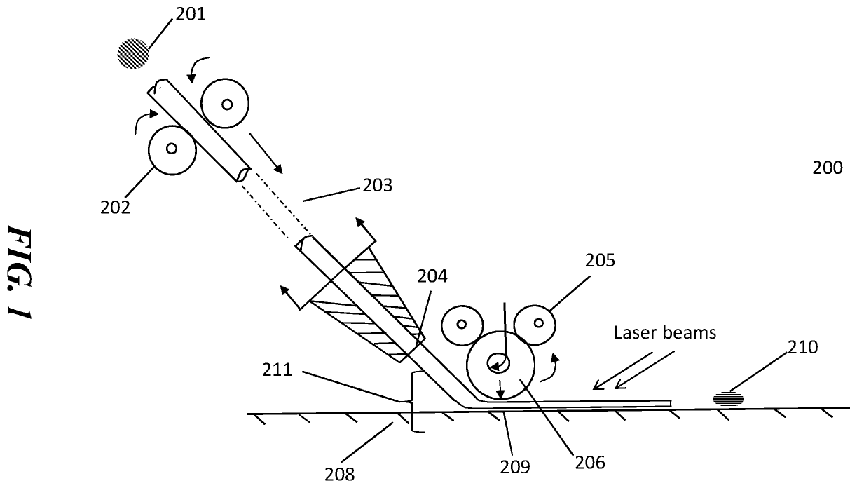

FIG. 1 illustrates another example system 200, which may be used to produce a three-dimensional object having any desired shape, size, and structure. System 200 may include an extender mechanism (or unit) 202 comprising one or more rollers for directing at least one filament material 203 from a source of at least one filament material towards a substrate 208. Such filament material may initially comprise an uncompressed cross section 201. The extender mechanism can include a motor for dispensing at least one filament material. This filament material may be used to adhere the printed object to the substrate. This filament material may be directed from the source to an opening, such as a nozzle 204, and can also be directed from the opening towards the substrate. The opening may receive at least one filament material, and can direct such filament material towards the substrate. The substrate may be adjacent to which the 3D object may be formed. Additionally, the substrate may include a drive mechanism (or unit) for moving the substrate.

Such filament material may also be directed to at least one freely suspended roller 206, thereby depositing a first layer corresponding to a portion of the 3D object on the substrate. The roller 206 may be moving along a direction from right to left in the context of FIG. 1. Next, the second layer of at least a portion of the 3D object may be deposited. One or more additional layers may be deposited adjacent to the first layer prior to depositing the second layer. In some cases, at least a first energy beam from at least one energy source may selectively melt at least a portion of the first layer and/or the second layer, thereby forming at least a portion of the 3D object. In some cases, at least a first energy beam from at least one energy source may selectively heat or melt at least a portion of the filament material being deposited and a previous layer of the 3D object (or other support). This heating or melting of both the filament material and a previous layer of the 3D object may result in greater mixing of the two materials and may allow for greater adhesion between the filament material and the previous layer of the 3D object (or other support).

In some examples, a first layer may be deposited adjacent to a support. The first layer may be deposited using at least one filament. Next, a second layer may be deposited adjacent to the first layer. The second layer may be deposited using the at least one filament or at least one other filament (e.g., in situations in which the material may be to be alternated). While the second layer may be deposited, an energy beam from at least one energy source may be used to heat at least a portion of the first layer and at least a portion of the filament being used to deposit the second layer. Such heating may be implemented using a defocused energy beam directed to both the at least the portion of the first layer and the at least the portion of the filament. The energy beam may be directed to area 211. The heating may liquefy or melt the portion of the at least the portion of the first layer and the at least the portion of the filament. The roller 206 may be used to compact such heated portions of the first layer and the filament. As an alternative or in addition to using an energy beam, other sources of energy may be used (e.g., a hot fluid or resistive heating).

The energy beam may be a laser beam. The energy source may be a laser head that may be mounted on a robot or similar mechanism that swivels around the vertical axis enabling deposition in any direction in the plane of deposition. At least one filament material may be fed into a nozzle at an angle such that it may be fed under at least one freely suspended roller at a nip point 209 as the at least one freely suspended roller presses this filament material exiting from the nozzle. The nip point may be the point where such filament material meets the substrate and may be pressed by the at least one freely suspended roller resulting in a compressed cross section 210.

The compaction unit may comprise at least one freely suspended roller that may be supported by one or more idler rollers 205. The at least one freely suspended roller may be designed to control the bend radii of such filament material. At least a portion of the three-dimensional object may be generated from such filament material continuously upon subjecting such deposited filament material to heating along the one or more locations. The system 200 may further comprise a controller operatively coupled to at least one light source.

The at least one energy source may be greater than or equal about 1, 2, 3, 4, 5, 6, 7, 8, 9, 10, 20, 30, 40, 50, or more optical energy sources, such as laser sources. The at least one energy source may be less than or equal to about 50, 40, 30, 20, 10, 9, 8, 7, 6, 5, 4, 3, 2, or 1 optical energy sources, such as laser sources. The at least one energy source may be 1 to 50, 1 to 40, 1 to 30, 1 to 20, 1 to 10, 1 to 5, 1 to 3, 2 to 50, 2 to 40, 2 to 30, 2 to 20, 2 to 10, 2 to 5, 3 to 50, 3 to 40, 3 to 30, 3 to 20, 3 to 10, or 3 to 5 optical energy sources, such as lasers. The laser sources may be independent laser sources or part of an array. For example, an array of light emitting diode (LED) energy sources may be used. One or more optics may be used to direct the at least one energy source to the part being heated, such as the first layer and the filament (e.g., the area 211).

In some embodiments, at least the first energy beam may be incident on at least one filament material and on the substrate. Such energy beams may be directed along a given angle among one or more angles relative to the dispensing route of at least one filament material. In some embodiments, at least one filament material may be directed to a compaction unit. Such filament material may be compacted by the compaction unit to form at least one compacted filament material. The compaction unit may comprise a rigid body, one or more idler rollers, at least one freely suspended roller, a coolant unit, or any combination thereof. The at least one freely suspended roller may be a compaction roller. The rigid body and one or more idler rollers may secure the at least one freely suspended roller. Such freely suspended rollers may have a diameter that may be greater than or equal to about 0.001 mm, 0.005 mm, 0.01 mm, 0.05 mm, 1 mm, 2 mm, 3 mm, 4 mm, 5 mm, 6 mm, 7 mm, 8 mm, 9 mm, 10 mm, 15 mm, 20 mm, 25 mm, 30 mm, 35 mm, 40 mm, 45 mm, 50 mm, 100 mm, or more. Such freely suspended rollers may have a diameter that may be less than or equal to about 100 mm, 50 mm, 45 mm, 40 mm, 35 mm, 30 mm, 25 mm, 20 mm, 15 mm, 10 mm, 9 mm, 8 mm, 7 mm, 6 mm, 5 mm, 4 mm, 3 mm, 2 mm, 1 mm, 0.5 mm, 0.1 mm, 0.05 mm, 0.01 mm, 0.005 mm, 0.001 mm, or less. Such freely suspended rollers may have a diameter from about 0.001 mm to 100 mm, 0.001 mm to 50 mm, 0.001 mm to 45 mm, 0.001 mm to 40 mm, 0.001 mm to 35 mm, 0.001 mm to 30 mm, 0.001 mm to 25 mm, 0.001 mm to 20 mm, 0.001 mm to 15 mm, 0.001 mm to 10 mm, 0.001 mm to 5 mm, 0.001 mm to 1 mm, 0.001 mm to 0.5 mm, 0.001 mm to 0.1 mm, 0.001 mm to 0.05 mm, 0.001 mm to 0.01 mm, 0.001 mm to 0.005 mm, 0.1 mm to 100 mm, 0.1 mm to 50 mm, 0.1 mm to 45 mm, 0.1 mm to 40 mm, 0.1 mm to 35 mm, 0.1 mm to 30 mm, 0.1 mm to 25 mm, 0.1 mm to 20 mm, 0.1 mm to 15 mm, 0.1 mm to 10 mm, 0.1 mm to 5 mm, 0.1 mm to 1 mm, 0.1 mm to 0.5 mm, 1 mm to 15 mm, 1 mm to 10 mm, 1 mm to 5 mm, 5 mm to 15 mm, or 5 mm to 10 mm. Such freely suspended rollers may have a diameter that may be about 22 mm, 23 mm, 24 mm, or 25 mm. The coolant may be used to cool the compaction unit so the at least one filament material does not stick to the roller and adheres only to the previously deposited layer of the three-dimensional object.

The system for printing at least a portion of the 3D object may further comprise one or more cooling components. Such cooling components may be in proximity to the deposited filament material layer. Such cooling components may be located between the deposited filament material layer and the energy source. Such cooling components may be movable to or from a location that may be positioned between the filament material and the energy source. Such cooling components may assist in the process of cooling of the fused portion of the filament material layer. Such cooling components may also assist in the cooling of the filament material layer remainder that did not fuse to subsequently form at least a portion of the 3D object. Such cooling components may assist in the cooling of the at least a portion of the 3D object and the remainder at considerably the same rate. Such cooling components may be separated from the filament material layer and/or from the substrate by a gap. The gap may comprise a gas. The gap may have a cross-section that may be greater than or equal to about 0.1 mm, 0.5 mm, 1 mm, 5 mm, 10 mm, or more. The gap can have a cross-section that may be less than or equal to about 10 mm, 5 mm, 1 mm, 0.5 mm, 0.01 mm, 0.005 mm, 0.001 mm, or less. The gap may have a cross-section that may be from about 0.001 mm to 10 mm, from about 0.001 mm to 5 mm, 0.001 mm to 1 mm, from about 0.001 mm to 0.5 mm, from about 0.001 mm to 0.1 mm, from about 0.001 mm to 0.05 mm, from about 0.001 mm to 0.01 mm, from about 0.001 mm to 0.005 mm, from about 0.1 mm to 10 mm, from about 0.1 mm to 5 mm, 0.1 mm to 1 mm, from about 0.1 mm to 0.5 mm, from about 1 mm to 10 mm, or from about 1 mm to 5 mm. The gap may have a cross-section that may be about 1 mm. The gap may be adjustable. The controller may be operatively connected to such cooling components and may be able to adjust the gap distance from the substrate. Such cooling components may track an energy that may be applied to the portion of the filament material layer by the energy source. Such cooling components may comprise a heat sink. Such cooling components may be a cooling fan. The controller may be operatively coupled to such cooling components and controls the tracing of such cooling components. Such cooling components may include at least one opening though which at least one energy beam from the energy source can be directed to the portion of the filament layer. The system for printing at least a portion of the 3D object may further comprise an additional energy source that provides energy to a remainder of the filament material layer that did not fuse to subsequently form at least a portion of the 3D object.

During printing of the three-dimensional object, certain parameters may be critical to printing high quality parts. One or more sensors may be used to measure one or more temperature(s) along at least one filament material. Such sensors may control intensities, positions, and/or angles of at least the first energy beam. The one or more sensors may be an optical pyrometer. Optical pyrometers may be aimed the substrate to detect the temperature of the at least one filament materials as they may be deposited. Optical pyrometers may be aimed at the nip points and one or more points before and/or after the compaction unit to detect the temperature of the at least one filament materials as they may be deposited. The temperature may vary from region to region of the filament material layer. Factors that affect temperature variance may include variable heater irradiance, variations in absorptivity of the composition, substrate temperature, filament material temperature, unfused filament material temperature, and the use of modifiers and additives. Accordingly, image and temperature measurement inputs based upon layer temperature patterns captured by the one or more sensors may be used. The real time temperature inputs and the sintering model may be factors determining an energy requirement pattern for any one or more subsequent layers.

Additionally, the system may comprise a real time simulation program, such as to provide feedback control of a given location, direction, or angle of at least the first energy beam normal to the substrate and/or along the substrate among one or more locations, directions, or angles. The real time simulation program may be a feedback control system. The feedback control system may be a Zemax simulation of the beam propagation.

Other parameters critical to printing high quality parts may include substrate temperature, melt zone temperature, as-built geometry, surface roughness and texture and density. Other critical visible or non-visible metrics may include characterization of chemistry, bonding or adhesion strength. Measuring one or more structural or internal properties of the part may comprise one or more methods selected from the group consisting of scattered and reflected or absorbed radiation, x-ray imaging, sound waves, scatterometry techniques, ultrasonic techniques, X-ray Photoelectron Spectroscopy (XPS), Four Transform Infrared Spectroscopy (FTIR), Raman Spectroscopy, Laser-Microprobe Mass Spectrometry (LMMS), and any combination thereof. Specific metrology beneficial to the end goals of characterizing the critical process parameters may be used. This in-situ metrology coupled with fast processing of data may enable open or closed loop control of the manufacturing process. Sensors appropriate to the key parameters of interest may be selected and utilized during the part printing process. The sensors may also comprise a camera for detecting light in the infrared or visible portion of the electromagnetic spectrum. Sensors such as IR cameras may be used to measure temperature fields. An image processing algorithm may be used to evaluate data generated by one or more sensors, to extract one or more structural or internal properties of the part. Visual (e.g., high magnification) microscopy from digital camera(s) may be used with proper software processing to detect voids, defects, and surface roughness. In order to utilize this technique, potentially large quantities of data may need to be interrogated using image processing algorithms in order to extract features of interest. Scatterometry techniques may be adapted to provide roughness or other data.

Ultrasonic techniques may be used to measure solid density and fiber and particle density which in turn may be useful in characterizing bond strength and fiber dispersion. The characterization may affect material strength. Ultrasonic techniques may also be used to measure thickness of features. Chemical bonding characterization, which may be useful for understanding fiber and/or matrix adhesion and layer-to-layer bonding, can be performed by multiple techniques such as XPS (X-ray Photoelectron Spectroscopy), FTIR (Four Transform Infrared Spectroscopy) and Raman Spectroscopy and Laser-Microprobe Mass Spectrometry (LMMS). One or more of these techniques may be utilized as part of the in-situ metrology for 3D printing. Ex-situ techniques may also be utilized in order to help provide appropriate calibration data for the in-situ techniques.

Sensors may be positioned on the robot end-effector of the three-dimensional printer in order to provide a sensor moving along with the deposited material. A robot end-effector may be a device positioned at the end of a robotic arm. The robot end-effector may be programmed to interact with its surrounding environment. Sensors may be also located at other various positions. The positions may be on-board the robot, on the effector, or deployed in the environment. Sensors may be in communication with the system. The system may further comprise one or more processors, a communication unit, memory, power supply, and storage. The communications unit may comprise an input and an output. The communication unit may be wired or wireless. The sensor measurements may or may not be stored in a database, and may or may not be used in future simulation and optimization operations. In-situ measurements may also be made using alternative methods with sensors in a cell but not directly attached to the robot end-effector.

In another aspect, the present disclosure may provide a system for printing at least a portion of a three-dimensional (3D) object. The system may comprise a source of at least one filament material that is configured to supply at least one filament material for generating the 3D object. The system may comprise a substrate for supporting at least a portion of the 3D object. The system may additionally comprise at least one energy source configured to deliver at least a first energy beam. The system may comprise a controller operatively coupled to the at least one energy source, wherein the controller may be programmed to receive, in computer memory, a model of the 3D object. Next, the controller may be programmed to direct at least one filament material from a source of the at least one filament material towards a build platform configured to support the 3D object, thereby depositing a first layer corresponding to a portion of the 3D object adjacent to the build platform, which first layer may be deposited in accordance with the model of the 3D object. The controller may be programmed to use the at least one filament material to deposit a second layer corresponding to at least a portion of the 3D object, which second layer may be deposited in accordance with the model of the 3D object. In some instances, while the second layer may be being deposited, the controller may be programmed to use at least a first energy beam from at least one energy source to selectively heat a first portion of the first layer and a second portion of the at least one filament material, which first portion may be brought in contact with the second portion.

The controller may be further programmed to deposit one or more additional layers adjacent to the second layer. In other instances, one or more additional layers may be deposited adjacent to the second layer while the first energy beam selectively may heat a first portion of the previously deposited layer and a second portion of the at least one filament material. The system may further comprise an opening for (i) receiving at least one filament material, and (ii) directing at least one filament material towards the substrate.

The layered structure may comprise substantially repetitive layers. The layers may have an average layer size that may be greater than or equal to about 0.01 μm, 0.1 μm, 0.5 μm, 1 μm, 5 μm, 10 μm, 20 μm, 30 μm, 40 μm, 50 μm, 60 μm, 70 μm, 80 μm, 90 μm, 100 μm, 150 μm, 200 μm, 250 μm, 300 μm, 350 μm, 400 μm, 450 μm, 500 μm, 1 min, 25 mm, 50 mm, 100 mm, 500 mm, or more. The layers may have an average layer size that may be less than or equal to about 500 mm, 100 mm, 50 mm, 25 mm, 1 mm, 500 μm, 450 μm, 400 μm, 350 μm, 300 μm, 250 μm, 200 μm, 150 μm, 100 μm, 90 μm, 80 μm, 70 μm, 60 μm, 50 μm, 40 μm, 30 μm, 20 μm, 10 μm, or less. The layers may have an average layer size of any value between the aforementioned values of layer size. The layers may have an average layer size from about 0.01 μm to about 500 mm, from about 0.01 μm to about 100 mm, from about 0.01 μm to about 50 mm, from about 0.01 μm to about 1 mm, from about 0.01 μm to about 500 μm, from about 0.01 μm to about 100 μm, from about 0.01 μm to about 50 μm, from about 0.01 μm to about 10 μm, from about 0.01 μm to about 1 μm, from about 0.01 μm to about 0.1 μm, from about 1 μm to about 500 min, from about 1 μm to about 100 mm, from about 1 μm to about 50 mm, from about 1 μm to about 1 mm, from about 1 μm to about 500 μm, from about 1 μm to about 100 μm, from about 1 μm to about 50 μm, from about 1 μm to about 10 μm, from about 100 μm to about 500 mm, from about 100 μm to about 100 mm, from about 100 μm to about 50 mm, from about 100 μm to about 1 mm, from about 1.00 μm to about 500 μm, from about 1 mm to about 500 mm, from about 1 mm to about 100 mm, from about 1 mm to about 50 mm, from about 1 μm to about 25 mm, from about 0.5 μm to about 500 mm, from about 15 μm to about 100 μm, from about 5 μm to about 300 μm, from about 20 μm to about 90 μm, or from about 10 μm to about 70 μm. The layered structure can be indicative of layered deposition. The layered structure may be indicative of solidification of melt pools formed during a three dimensional printing process, such as by selective energy melting. The structure indicative of a three dimensional printing process may comprise substantially repetitive variation comprising: variation in grain orientation, variation in material density, variation in the degree of compound segregation to grain boundaries, variation in the degree of element segregation to grain boundaries, variation in material phase, variation in metallurgical phase, variation in material porosity, variation in crystal phase, or variation in crystal structure.

The source of at least one filament material may be configured to supply at least one filament material for generating the three-dimensional object. The at least one filament material may be stored on one or more spools or cartridges. The spools and/or cartridges may be replaceable. The at least one filament material may be a composite material, such as a continuous fiber composite. The filament material may comprise one or more elements selected from the group consisting of nano milled fiber, short fiber, long fiber, continuous fiber, or a combination thereof. The continuous fiber composite may be a continuous core reinforced filament. The at least one filament may be substantially void free and may include a polymer that coats or impregnates an internal continuous core. Depending upon the particular embodiment, the core may be a solid core or it may be a multi-strand core comprising multiple strands. The continuous fiber composite may be selected from the group consisting of glass, carbon, aramid, cotton, silicon carbide, polymer, wool, metal, and any combination thereof.

The feedstock or filament material may have a cross sectional ratio of a first dimension to a second dimension (orthogonal to the first dimension) that may be less than or equal to about 1000:1, 500:1, 400:1, 300:1, 200:1, 100:1, 50:1, 40:1, 30:1, 20:1, 10:1, 5:1, 4:1, 3:1, 2:1, 1:1, 1:2, 1:3, 1:4, 1:5, 1:10, 1:20, 1:30, 1:40, 1:50 or less. In some example, the first dimension is a width and the second dimension is a height along a given cross-section of the feedstock. The ratio may be greater than or equal to about 1:5, 1:4, 1:3, 1:2, 1:1, 2:1, 3:1, 4:1, 5:1, 6:1, 7:1, 8:1, 9:1, 10:1, or more. The ratio may be such that the feedstock is symmetrical about a given plane. In other instance, the ratio may be such that the feedstock is not symmetrical about a given plane. The ratio may be such that the feedstock is not tape or tape-like. The ratio may be from about 20:1 to 1:20, or 10:1 to 1:10, or 5:1 to 1:5, or 2:1 to 1:2, or 1.5:1 to 1:1.5. In some examples, a ratio of about 1:1 is for a feedstock with a circular or box-like cross-section.

The filament material may incorporate one or more additional materials, such as resins and polymers. For example, appropriate resins and polymers include, but may not be limited to, acrylonitrile butadiene styrene (ABS), epoxy, vinyl, nylon, polyetherimide (PEI), Polyaryletherketone (PAEK), Polyether ether ketone (PEEK), Polyactic Acid (PLA), Liquid Crystal Polymer, polyamide, polyimide, polyphenylene sulfide, polyphenylsulfone, polysulfone, polyether sulfone, polyethylenimine, polytetrafluoroethylene, polyvinylidene, and various other thermoplastics. The core of the continuous fiber composite may be selected to provide any desired property. Appropriate core fiber or strands include those materials which impart a desired property, such as structural, conductive (electrically and/or thermally), insulative (electrically and/or thermally), optical and/or fluidic transport. Such materials include, but may not be limited to, carbon fibers, aramid fibers, fiberglass, metals (such as copper, silver, gold, tin, and steel), optical fibers, and flexible tubes. The core fiber or strands may be provided in any appropriate size. Further, multiple types of continuous cores may be used in a single continuous core reinforced filament to provide multiple functionalities such as electrical and optical properties. A single material may be used to provide multiple properties for the core reinforced filament. For example, a steel core may be used to provide both structural properties as well as electrical conductivity properties.

Alternatively, the filament material may comprise metal particles infused into a binder matrix. The metal particles may be metal powder. The binder matrix may include resins or polymers. Additionally, such binder matrix can be used a delivery device for the metal particles. Once the filament material is deposited onto the base, one or more energy sources can heat and melt the binder matrix, leaving the metal particles to melt and fuse into larger metal particles. Such energy sources may be without limitation, by a laser, a microwave source, a resistive heating source, an infrared energy source, a UV energy source, a hot fluid, a chemical reaction, a plasma source, a microwave source, an electromagnetic source, or an electron beam. Resistive heating may be joule heating. A source for resistive heating may be a power supply. The at least one filament material may be a metal filament. The at least one filament material may be a metal filament composite. The deposited at least one filament material may be subjected to resistive heating upon flow of an electrical current through the at least one filament material. The resistive heating may be sufficient to melt at least a portion of the deposited at least one filament material. The at least one filament material may be an electrode. The substrate may be another electrode.

The one or more energy sources may also provide localized heating to create a “melt pool” in the current layer or segment of the deposited build material prior to depositing the next segment or layer. The melt pool may increase diffusion and mixing of the build material between adjacent layers (e.g., across a direction orthogonal to the layers) as compared to other methods which deposit a subsequent layer of build material on top of a layer of build material that is below its melting temperature.

The hot fluid may have a temperature greater than or equal to about 25° C., 40° C., 50° C., 60° C., 70° C., 80° C., 90° C., 100° C., 150° C., 200° C., 250° C., 300° C., 350° C., 400° C., 450° C., 500° C., or more. The hot fluid may have a temperature that may be less than or equal to about 500° C., 450° C., 400° C., 350° C., 300° C., 250° C., 200° C., 150° C., 100° C., 50° C., or less. The hot fluid may have a temperature from about 25° C. to 500° C., 25° C. to 400° C., 25° C. to 300° C., 25° C. to 200° C., 25° C. to 100° C., 25° C. to 50° C., 100° C. to 500° C., 100° C. to 400° C., 100° C. to 300° C., 100° C. to 200° C., 300° C. to 500° C., or 300° C. to 400° C. The temperature of the hot fluid may be dependent on the material of the at least one filament. The hot fluid may have a temperature that may be selected to soften or melt a material used to print an object. The hot fluid may have a temperature that may be at or above a melting point or glass transition point of a polymeric material. The hot fluid can be a gas or a liquid. In some examples, the hot fluid may be air. In some examples, the hot fluid may be argon.

The increased diffusion and mixing resulting from the melt pool may increase the chemical chain linkage, bonding, and chemical chain interactions between the two layers. This may result in increasing the build-material adhesion in the Z direction, thereby enhancing mechanical, thermal, and electrical properties of the three-dimensional object. The melt pool may also reduce the void space and porosity in the build object. Among other benefits, this may decrease in porosity which may also contribute to the aforementioned improvement in mechanical, thermal, and electrical properties.

The at least one filament material may have a cross sectional shape selected from the group consisting of circle, ellipse, parabola, hyperbola, convex polygon, concave polygon, cyclic polygon, equilateral polygon, equiangular polygon, regular convex polygon, regular star polygon, tape-like geometry, and any combination thereof. Such filament material may have a diameter that may be greater than or equal to about 0.1 mm, 0.2 mm, 0.3 mm, 0.4 mm, 0.5 mm, 0.6 mm, 0.7 mm, 0.8 mm, 0.9 mm, 1 mm, 2 mm, 3 mm, 4 mm, 5 mm, 10 mm, 20 mm, or more. Such filament material may have a diameter that may be less than or equal to about 20 mm, 10 mm, 5 mm, 4 mm, 3 mm, 2 mm, 1 mm, 0.9 mm, 0.8 mm, 0.7 mm, 0.6 mm, 0.5 mm, 0.4 mm, 0.3 mm, 0.2 mm, 0.1 mm, or less. Such filament material may have a diameter of from about 0.1 mm to 20 mm, 0.1 mm to 5 mm, 0.1 mm to 1 mm, 0.1 mm to 0.5 mm, 0.5 mm to 20 mm, 0.5 mm to 5 mm, 0.5 mm to 1 mm, 1 mm to 20 mm, or 1 mm to 5 mm.

Various modifiers within the layers themselves may be used which may be selectively printed onto specific regions of the 3D object in order to impart various desirable mechanical, chemical, magnetic, electrical or other properties to the 3D object. Such modifiers may be selected from the group consisting of thermal conductors and insulators, dielectric promoters, electrical conductors and insulators, locally-contained heater traces for multi-zone temperature control, batteries, and sensors. In some embodiments, at least one print head may be used for printing such modifiers. As desired, such modifiers may be printed before at least a first energy beam is directed onto at least a portion of the first layer and/or second layer. Alternatively, such modifiers may be printed over a layer that has been melted, before filament material for the next layer is deposited.

For example, when printing a polyimide part from commercially available a filament comprising polyimide, an array of electrically conductive traces may be assimilated as an antenna to selectively absorb radiofrequency (RF) radiation within a specific and predetermined frequency range. The 3D object CAD model and software may designate as a sub-part the layer(s) that comprise the traces for modified properties (high electrical conductivity). Alternatively, if these portions of the layer entail different levels of energy for inducing fusion, compared to other regions having only the primary material, the CAD model and design of the 3D object may be adjusted accordingly.

In some embodiments, the system for printing at least a portion of a three-dimensional object may comprise a build plate form. The system may also comprise a substrate. The substrate may be able to withstand high temperatures. The substrate may have high thermal tolerances, and may be able to withstand high temperatures that may be greater than or equal to about 50° C., 100° C., 150° C., 200° C., 250° C., 300° C., 350° C., 400° C., or more. The substrate may have high thermal tolerances, and may be able to withstand high temperatures, that may be less than or equal to about 400° C., 350° C., 300° C., 250° C., 200° C., 150° C., 100° C., 50° C., or less. The substrate may have high thermal tolerances, and may be able to withstand high temperatures from about 50° C. to about 400° C., from about 50° C. to about 350° C., from about 50° C. to about 300° C., from about 50° C. to about 250° C., from about 50° C. to about 200° C., from about 50° C. to about 150° C., from about 50° C. to about 100° C., from about 100° C. to about 400° C., from about 100° C. to about 350° C., from about 100° C. to about 300° C., from about 100° C. to about 250° C., from about 100° C. to about 200° C., from about 100° C. to about 150° C., from about 200° C. to about 400° C., from about 200° C. to about 350° C., from about 200° C. to about 300° C., from about 200° C. to about 250° C., from about 300° C. to about 400° C., from about 300° C. to about 350° C., or from about 350° C. to about 400° C. The high thermal temperature tolerance may be dependent on the material of the substrate.

The substrate may be thermally conductive in nature, so that it may be heated. The substrate may be heated from the heated build platform by the temperature control components, such as heater cartridges. Further, the substrate may be made of a material having a low coefficient of thermal expansion (CTE), to avoid expansion of the plate as it is heated up due to the heated build platform. In an embodiment, the material for the substrate may be aluminum, steel, brass, ceramic, glass, or alloys similar with low coefficient of thermal expansion (CTE). The substrate may have a thickness that may be greater than or equal to about 0.1 inches (in), 0.2 in, 0.3 in, 0.4 in, 0.5 in, 0.6 in, 0.7 in, 0.8 in, 0.9 in, 1 in, 2 in, 3 in, 4 in, 5 in, or more. The substrate may have a thickness that may be less than or equal to about 5 in, 4 in, 3 in, 2 in, 1 in, 0.9 in, 0.8 in, 0.7 in, 0.6 in, 0.5 in, 0.4 in, 0.3 in, 0.2 in, 0.1 in, or less. The substrate may have a thickness of from about 0.1 in to 5 in, from about 0.1 in to about 5 in, from about 0.1 in to about 5 in, from about 0.5 in to about 5 in, from about 0.5 in to about 1 in, from about 0.5 in to about 0.6 in, or from about 1 in to about 5 in. Further, the thickness of the substrate may also depend on the flexural character of the material. The substrate may be thin enough to allow for minor flexing for the removal of the 3D object. Additionally, the substrate may not be too thin such that heating of the substrate results in rippling, bowing, or warping and resulting in a print surface that is uneven or not consistently level. Furthermore, the substrate may be able to withstand high temperatures that may be greater than or equal to about 50° C., 100° C., 150° C., 200° C., 250° C., 300° C., 350° C., 400° C., or more. The substrate may be able to withstand high temperatures that may be less than or equal to about 400° C., 350° C., 300° C., 250° C., 200° C., 150° C., 100° C., 50° C., or less. The substrate may be able to withstand high temperatures of from about 50° C. to about 400° C., about 50° C. to about 350° C., about 50° C. to about 300° C., about 50° C. to about 250° C., about 50° C. to about 200° C., about 50° C. to about 150° C., about 50° C. to about 100° C., about 100° C. to about 400° C., about 100° C. to about 350° C., about 100° C. to about 300° C., about 100° C. to about 250° C., about 100° C. to about 200° C., about 100° C. to about 150° C., about 200° C. to about 400° C., about 200° C. to about 350° C., about 200° C. to about 300° C., about 200° C. to about 250° C., or about 300° C. to about 400° C.

The substrate may possess flexibility owing to the type of material it is made of. The flexibility of the substrate may allow for easier dissociation between the 3D object and the substrate upon cooling. Further, this flexibility can also reduce the possibility of damage to the 3D object during object removal since a blade or wedge is no longer needed to pry off the object. Once the printing of the 3D object is completed, the 3D object may pop off the substrate when the substrate and 3D object has cooled.

In some embodiments, the system for printing at least a portion of a 3D object may comprise one or more heater cartridges with thermal control from PID controllers connected to thermocouples. The heater cartridges may function as a temperature control for the system. The one or more thermocouples may be situated at one or several locations to provide feedback to a controller, such as a PID controller, and hence maintain temperature set points throughout a build. The system may comprise a jacket cover outside of the print head to contain and direct the flow of the hot fluid (e.g., hot air) towards the layers of the deposited portion of the 3D object.

The controller may be configured after deposition of a first layer and/or a second layer of at least a portion of the 3D object, and before fusion may be induced, to preheat the filament material to a temperature sufficient to reduce undesirable shrinkage and/or to minimize the laser energy needed to melt the next layer. For example, the preheating may be accomplished using the infrared heater attached to substrate or through other apparatuses of directing thermal energy within an enclosed space around the substrate. Alternatively, the preheating may be accomplished using energy beam melting by defocusing the energy beam and rapidly scanning it over the deposited first layer and or second layer of at least a portion of the 3D object.

In some embodiments, the controller may be configured using at least a first energy beam from at least one energy source to selectively heat and/or melt at least a portion of the first layer and/or the second layer, thereby forming at least a portion of the 3D object. The energy source may be selected from the group consisting of a laser, a microwave source, a resistive heating source, an infrared energy source, a UV energy source, a hot fluid, a chemical reaction, a plasma source, a microwave source, an electromagnetic source, an electron beam, or any combination thereof. Resistive heating may be joule heating. A source for resistive heating may be a power supply. The at least one filament material may be a metal filament. The at least one filament material may be a metal filament composite. The deposited at least one filament material may be subjected to resistive heating upon flow of an electrical current through the at least one filament material. The resistive heating may be sufficient to melt at least a portion of the deposited at least one filament material. The at least one filament material may be an electrode. The substrate may be another electrode.

The energy source may be a function of the chemical composition of the build material, such as the build material's thermal conductivity, heat capacity, latent heat of fusion, melting point, and melt flow viscosity. The at least one energy source may be a laser. The laser may be selected from the group consisting of gas lasers, chemical lasers, dye lasers, metal-vapor lasers, solid-state lasers, semiconductor lasers, free electron laser, gas dynamic laser, nickel-like samarium laser, Raman laser, nuclear pump laser, and any combination thereof. Gas lasers may comprise one or more of helium-neon laser, argon laser, krypton laser, xenon ion laser, nitrogen laser, carbon dioxide laser, carbon monoxide laser, and excimer laser. Chemical lasers may be selected from the group consisting of hydrogen fluoride laser, deuterium fluoride laser, chemical oxygen-iodine laser, all gas-phase iodine laser, and any combination thereof. Metal-vapor lasers can comprise one or more of helium-cadmium, helium mercury, helium selenium, helium silver, strontium vapor laser, neon-copper, copper vapor laser, gold vapor laser, and manganese vapor laser. Solid-state lasers may be selected from the group consisting of ruby laser, neodymium-doped yttrium aluminium garnet laser, neodymium and chromium-doped yttrium aluminium garnet laser, erbium-doped yttrium aluminium garnet laser, neodymium-doped yttrium lithium fluoride laser, neodymium doped yttrium othovanadate laser, neodymium doped yttrium calcium oxoborate laser, neodymium glass laser, titanium sapphire laser, thulium yttrium aluminium garnet laser, ytterbium yttrium aluminium garnet laser, ytterbium:₂O₃ (glass or ceramics) laser, ytterbium doped glass laser (rod, plate/chip, and fiber), holmium yttrium aluminium garnet laser, chromium zinc selenium laser, cerium doped lithium strontium (or calcium) aluminum fluoride laser, Promethium 147 doped phosphate glass solid-state laser, chromium doped chrysoberyl (alexandrite) laser, erbium doped and erbium-ytterbium codoped glass lasers, trivalent uranium doped calcium fluoride solid-state laser, divalent samarium doped calcium fluoride laser, FARBE center laser, and any combination thereof. Semiconductor laser may comprise one or more of semiconductor laser diode laser, gallium nitride laser, indium gallium nitride laser, aluminium gallium indium phosphide laser, aluminium gallium arsenide laser, indium gallium arsenide phosphide laser, lead salt laser, vertical cavity surface emitting laser, quantum cascade laser, and hybrid silicon laser.

The melting temperature of the at least one filament material may be greater than or equal to about 100° C., 150° C., 200° C., 250° C., 300° C., 350° C., 400° C., 450° C., or more. The melting temperature of the at least one filament material may be less than or equal to about 450° C., 400° C., 350° C., 300° C., 250° C., 200° C., 150° C., 100° C., or less. The melting temperature of the at least one filament material may be from about 150° C. to about 450° C., from about 150° C. to about 400° C., from about 150° C. to about 350° C., from about 150° C. to about 300° C., from about 150° C. to about 250° C., from about 150° C. to about 200° C., from about 250° C. to about 450° C., from about 250° C. to about 400° C., from about 250° C. to about 350° C., from about 250° C. to about 300° C., from about 350° C. to about 450° C., or from about 350° C. to about 400° C.

The sintering temperature of the at least one filament material may be greater than or equal to about 100° C., 150° C., 200° C., 250° C., 300° C., 350° C., 400° C., or more. The sintering temperature of the at least one filament material may be less than or equal to about 400° C., 350° C., 300° C., 250° C., 200° C., 150° C., or less. The sintering temperature of the at least one filament material may be from about 150° C. to about 400° C., from about 150° C. to about 350° C., from about 150° C. to about 300° C., from about 150° C. to about 250° C., from about 150° C. to about 200° C., from about 250° C. to about 400° C., from about 250° C. to about 350° C., from about 250° C. to about 300° C., from about 350° C. to about 450° C., or from about 350° C. to about 400° C.

The controller may further be programmed to separate the remainder of the layer that did not fuse and solidify to form at least a portion of the three dimensional object, from the portion. The controller may be programmed to direct delivery of the three dimensional object to a customer. The controller may be programmed to direct packaging the three dimensional object.

The controller may be programmed to direct at least one energy beam from the energy source may be directed to the at least one portion of the 3D object adjacent to the substrate. Such energy beams may be sufficient to induce fusion of particles of the filament material within the desired cross-sectional geometry of the at least one portion of the 3D object. As the energy dissipates with cooling, atoms from neighboring particles may fuse together. In some embodiments, the at least one energy beam may result in the fusion of particles of filament material both within the same layer and in the previously formed and resolidified adjoining layer(s) such that fusion may be induced between at least two adjacent layers of the part, such as between at least one filament material in a deposited unfused layer and a previously-fused adjacent layer. The controller may be further programmed to repeat such process over multiple cycles as each part layer may be added, until the full 3D object may be formed.

In some cases, to create a melt pool large enough to span the width of the filament material segment, multiple energy sources or a combination of energy sources may be required. When multiple energy sources are used, the energy sources may be the same energy source. Alternatively, the multiple energy sources may be different energy sources. The energy source(s) may be separate from the system for printing at least a portion of the 3D object. In some other embodiments, the energy source(s) may be integrated with such system. For example, in one embodiment, a hot fluid may be channeled through the deposition nozzle. Because the material filament may flow in the melt pool, features of the 3D object being built may be altered. In some embodiments, the melt pool may be formed within the build object, such that a melt pool may not be formed near the perimeters thereof. To accomplish this, the energy source may be turned off when the perimeters of the object may be built. In such embodiments, the geometrical tolerance of the build object may be maintained while the interior of the object has enhanced interlayer bonding. During printing, the filament material may be printed in the X, Y, and Z directions in one segment or layer.

In some embodiments, the controller may be programmed so that at least the first energy beam may be incident on at least one filament material and on the substrate. Such energy beams may be directed along a given angle among one or more angles relative to the dispensing route of at least one filament material. In other instances, the controller may program the at least one filament material to be directed to a compaction unit. Such filament material may be compacted by such a compaction unit to form at least one compacted filament material. The compaction unit may comprise a rigid body, one or more idler rollers, at least one freely suspended roller, a coolant unit, or any combination thereof. The at least one freely suspended roller may be a compaction roller. The controller may direct the rigid body and one or more idler rollers to secure the at least one freely suspended roller. Such freely suspended rollers may have a diameter that may be greater than or equal to about 1 mm, 2 mm, 3 mm, 4 mm, 5 mm, 6 mm, 7 mm, 8 mm, 9 mm, 10 mm, 15 mm, or more. Such freely suspended rollers may have a diameter that may be less than or equal to about 15 mm, 10 mm, 9 mm, 8 mm, 7 mm, 6 mm, 5 mm, 4 mm, 3 mm, 2 mm, 1 mm, or less. The freely suspended rollers may have a diameter of from about 1 mm to 15 mm, from about 1 mm to 10 mm, from about 1 mm to 5 mm, from about 1 mm to 2 mm, from about 3 mm to 15 mm, from about 3 mm to 10 mm, from about 3 mm to 5 mm, from about 5 mm to 15 mm, or from about 5 mm to 10 mm. The controller may direct the coolant to cool the compaction unit so the at least one filament material does not stick to the roller and adheres to the previously deposited layer of the three-dimensional object.

The system for printing at least a portion of the 3D object may further comprise one or more cooling components. Such cooling components may be separated from the filament material layer and/or from the substrate by a gap. The gap may comprise a gas. The gap can have a cross-section that may be greater than or equal to about 0.001 mm, 0.005 mm, 0.01 mm, 0.05 mm, 0.1 μm, 0.5 mm, 1 mm, 5 mm, 10 μm, or more. The gap can have a cross-section that may be less than or equal to about 10 mm, 5 mm, 1 mm, 0.5 mm, 0.1 mm, 0.05 mm, 0.01 mm, 0.005 mm, 0.001 mm, or less. The gap may have a cross-section that may be from about 0.001 mm to 10 mm, from about 0.001 mm to 5 mm, 0.001 mm to 1 mm, from about 0.001 mm to 0.5 mm, from about 0.001 mm to 0.1 mm, from about 0.001 mm to 0.05 mm, from about 0.001 mm to 0.01 mm, from about 0.001 mm to 0.005 mm, from about 0.1 mm to 10 mm, from about 0.1 mm to 5 mm, 0.1 mm to 1 mm, from about 0.1 mm to 0.5 mm, from about 1 mm to 10 mm, or from about 1 mm to 5 mm. The gap may be adjustable. The controller may be operatively connected to such cooling components and may be able to adjust the gap distance from the substrate. Such cooling components may track an energy that may be applied to the portion of the filament material layer by the energy source. Such cooling components may comprise a heat sink. Such cooling components may be a cooling fan. The controller may be operatively coupled to such cooling components and controls the tracing of such cooling components. Such cooling components may include at least one opening though which at least one energy beam from the energy source can be directed to the portion of the filament layer. The system for printing at least a portion of the 3D object can further comprise an additional energy source that provides energy to a remainder of the filament material layer that did not fuse to subsequently form at least a portion of the 3D object.

During printing of the three-dimensional object, certain parameters may be critical to printing high quality parts. One or more sensors may be used to measure one or more temperature(s) along at least one filament material. Such sensors may control intensities, positions, and/or angles of at least the first energy beam. The one or more sensors may be an optical pyrometer. The controller may direct the optical pyrometers to be aimed at the nip points and one or more points before and/or after the compaction unit to detect the temperature of the at least one filament materials as they are deposited. The temperature may vary from region to region of the filament material layer. Factors that affect temperature variance may include variable heater irradiance, variations in absorptivity of the composition, substrate temperature, filament material temperature, unfused filament material temperature, and the use of modifiers and additives. Accordingly, the controller may be programmed so that the image and temperature measurement inputs based upon layer temperature patterns captured by the one or more sensors may be used. The real time temperature inputs and the sintering model may be factors determining an energy requirement pattern for any one or more subsequent layers.

Additionally, the system may comprise a real time simulation program, which may provide feedback control of a given location, direction, or angle of at least the first energy beam normal to the substrate and/or along the substrate among one or more locations, directions, or angles. The real time simulation program may be a feedback control system. The feedback control system may be a Zemax simulation of the beam propagation.

Other parameters critical to printing high quality parts may include substrate temperature, melt zone temperature, as-built geometry, surface roughness and texture and density. Other critical visible or non-visible metrics include characterization of chemistry, bonding or adhesion strength. Measuring one or more structural or internal properties of the part can comprise one or more methods selected from the group consisting of scattered and reflected or absorbed radiation, x-ray imaging, sound waves, scatterometry techniques, ultrasonic techniques, X-ray Photoelectron Spectroscopy (XPS), Four Transform Infrared Spectroscopy (FTIR), Raman Spectroscopy, Laser-Microprobe Mass Spectrometry (LMMS), and any combination thereof. Specific metrology beneficial to the end goals of characterizing the critical process parameters can be used. This in-situ metrology coupled with fast processing of data may enable open or closed loop control of the manufacturing process. Sensors appropriate to the key parameters of interest can be selected and utilized during the part printing process. The sensors may also comprise a camera for detecting light in the infrared or visible portion of the electromagnetic spectrum. Sensors such as IR cameras may be used to measure temperature fields. An image processing algorithm may be used to evaluate data generated by one or more sensors, to extract one or more structural or internal properties of the part. Visual (e.g., high magnification) microscopy from digital camera(s) can be used with proper software processing to detect voids, defects, and surface roughness. In order to utilize this technique, potentially large quantities of data may need to be interrogated using image processing algorithms in order to extract features of interest. Scatterometry techniques may be adapted to provide roughness or other data.

Ultrasonic techniques may be used to measure solid density and fiber and particle density which in turn may be useful in characterizing bond strength and fiber dispersion. The characterization may affect material strength. Ultrasonic techniques may also be used to measure thickness of features. Chemical bonding characterization, which may be useful for understanding fiber and/or matrix adhesion and layer-to-layer bonding, may be performed by multiple techniques such as XPS (X-ray Photoelectron Spectroscopy), FTIR (Four Transform Infrared Spectroscopy) and Raman Spectroscopy and Laser-Microprobe Mass Spectrometry (LMMS). One or more of these techniques may be utilized as part of the in-situ metrology for 3D printing. Ex-situ techniques may also be utilized in order to help provide appropriate calibration data for the in-situ techniques.

Sensors may be positioned on the robot end-effector of the three-dimensional printer in order to provide a sensor moving along with the deposited material. A robot end-effector may be a device positioned at the end of a robotic arm. The robot end-effector may be programmed to interact with its surrounding environment. Sensors may be also located at other various positions. The positions may be on-board the robot, on the effector, or deployed in the environment. Sensors may be in communication with the system. The system may further comprise one or more processors, a communication unit, memory, power supply, and storage. The communications unit may comprise an input and an output. The communication unit may be wired or wireless. The sensor measurements may or may not be stored in a database, and may or may not be used in future simulation and optimization operations. In-situ measurements may also be made using alternative methods with sensors in a cell but not directly attached to the robot end-effector.

### Computer Systems

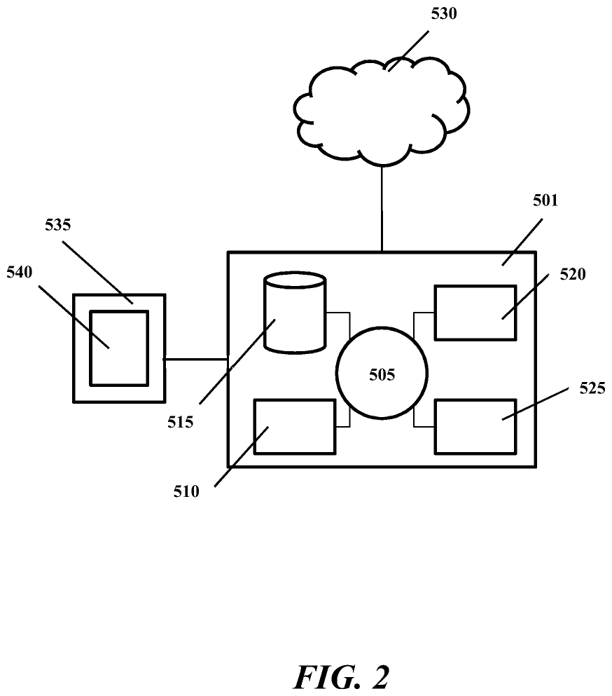

The present disclosure provides computer systems that are programmed or otherwise configured to implement methods of the present disclosure. FIG. 2 shows a computer system 501 that is programmed or otherwise configured to implement 3D printing methods provided herein. The computer system 501 can regulate various aspects of methods the present disclosure, such as, for example, partitioning a computer model of a part and generating a mesh array from the computer model.

The computer system 501 includes a central processing unit (CPU, also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are external to the computer system 501, such as located on a remote server that is in communication with the computer system 501 through an intranet or the Internet.

The computer system 501 can communicate with one or more remote computer systems through the network 530. For instance, the computer system 501 can communicate with a remote computer system of a user (e.g., customer or operator of a 3D printing system). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 535 that comprises a user interface (UI) 540 for providing, for example, a print head tool path to a user. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 505. The algorithm can, for example, partition a computer model of a part and generate a mesh array from the computer model.

The computer system 501 can include a 3D printing system. The 3D printing system may include one or more 3D printers. A 3D printer may be, for example, a fused filament fabrication (FFF) printer. Alternatively or in addition to, the computer system 501 may be in remote communication with the 3D printing system, such as through the network 530.

### Examples

In an example, prior to printing the 3D object, a request for production of a requested 3D object is received from a user (e.g., customer). A model of the 3D object may be received in computer memory. Next, a composite filament material may be directed from a spool toward a channel of the print head. The filament material may then be directed through a nozzle towards a substrate that is configured to support the 3D object. A first layer may be deposited corresponding to a portion of the 3D object adjacent to the substrate. The first layer in the X and Y direction may be deposited in accordance with the model of the 3D object. Additional layers may be deposited onto the first layer in the Z direction. During deposition, a portion of an additional layer and a portion of a previous layer may be heated at a point at a filament forming the additional layer is coming in contact with the previous layer. This may soften or liquefy portions of the layers.

A final layer of at filament material may be deposited. The system may comprise a heater cartridge with thermal control from PID controllers connected to sensors, such as one or more thermocouples and/or one or more optical thermal sensors (e.g., pyrometer). During deposition, the heater cartridges may control heating and/or the temperature for the system in accordance with the parameters for building the model of the 3D object. The sensors may provide feedback to the PID controller and may maintain temperature set points throughout the build process. A laser beam (or other heater) may then be used to selectively heat or melt several portions of the first and last deposited layer, thereby increasing adherence and fusion between adjacent layers. A part of the modulated laser beam may be focused by the focusing system, angled by a pair of optical wedges, and irradiated along the filament material for three-dimensional printing. The 3D object may be allowed to cool prior to removing the object from the substrate. The 3D object may be packaged and then delivered to the customer.

Examples of methods, systems and materials that may be used to create or generate objects or parts herein are provided in U.S. Patent Publication Nos. 2014/0232035, 2016/0176118, and U.S. patent application Ser. Nos. 14/297,185, 14/621,205, 14/623,471, 14/682,067, 14/874,963, 15/069,440, 15/072,270, 15/094,967, each of which is entirely incorporated herein by reference.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

1. A method for printing at least a portion of a three-dimensional (3D) object, comprising:
(a) receiving, in computer memory, a model of said 3D object;
(b) directing at least one filament material from a source of said at least one filament material towards a build platform, thereby depositing a first layer corresponding to a portion of said 3D object adjacent to said build platform, which first layer is deposited in accordance with said model of said 3D object;
(c) using said at least one filament material to deposit a second layer corresponding to at least a portion of said 3D object, which second layer is deposited in accordance with said model of said 3D object; and
(d) while said second layer is being deposited, using at least one energy beam from at least one energy source to selectively heat a first portion of said first layer and a second portion of said at least one filament material, which first portion is brought in contact with said second portion.

2. The method of claim 1, wherein said depositing of said first layer corresponding to said at least said portion of said 3D object is performed without heating said at least one filament material.

3. The method of claim 1, further comprising, prior to (b), directing at least one additional filament material from a source of said at least one additional filament material towards said build platform, thereby depositing at least one adhesion layer adjacent to said build platform to support said 3D object.

4. The method of claim 3, wherein said at least one additional filament material is said at least one filament material.

5. The method of claim 3, wherein said at least one adhesion layer is not part of said 3D object.

6. The method of claim 1, further comprising, prior to (c), heating at least a portion of said first layer.

7. The method of claim 1, further comprising depositing one or more additional layers over said first layer and said second layer.

8. The method of claim 1, further comprising compacting said first layer during or subsequent to deposition of said first layer.

9. The method of claim 1, further comprising compacting said first layer or said second layer during or subsequent to deposition of said first layer or said second layer.

10. The method of claim 9, further comprising compacting said second layer subsequent to heating said portion of said first layer and said second portion of said at least one filament material.

11. The method of claim 1, wherein in (d), said at least said one energy beam from said at least one energy source selectively melts said first portion of said first layer and said second portion of said at least one filament material.

12. The method of claim 1, wherein said at least one filament material is a bundle of filament materials.

13. The method of claim 12, wherein said bundle of filament material comprises a polymeric material and a reinforcing material.

14. The method of claim 1, wherein said at least one filament material comprises one or more elements selected from the group consisting of continuous fiber, long fiber, short fiber, and milled fiber.

15. The method of claim 1, wherein said at least one filament material comprises one or more elements selected from the group consisting of carbon nanotube, graphene, Bucky ball, and metallic material.

16. A method for printing at least a portion of a three-dimensional (3D) object, comprising:
receiving, in computer memory, a model of said 3D object;
using at least one feedstock from a source of said at least one feedstock to deposit a first layer adjacent to a build platform, which first layer is deposited in accordance with said model of said 3D object, wherein said at least one feedstock comprises a polymeric material and a reinforcing material as a bundle, and wherein a ratio of a first dimension to a second dimension orthogonal to said first dimension of said at least one feedstock is less than 10:1; and
using said at least one feedstock from said source of said at least one feedstock to deposit a second layer adjacent to said first layer, which second layer is deposited in accordance with said model of said 3D object.

17. The method of claim 16, wherein said at least one feedstock is not a tape.

18. The method of claim 16, wherein said ratio is less than 5:1.

19. The method of claim 16, wherein said ratio is less than 2:1.

20. The method of claim 16, wherein said ratio is from about 1:2 to 2:1.

21.-44. (canceled)
